(19) United States
(12) Patent Application Publication
(10) Pub. No.: US 2025/0061759 A1
(43) Pub. Date: Feb. 20, 2025

(54) ELECTRONIC LOCK WITH BATTERY USE MITIGATION

(71) Applicant: ASSA ABLOY Americas Residential Inc., New Haven, CT (US)

(72) Inventors: Kevin Pasma, Lake Forest, CA (US); Kevin Coleman, Lake Forest, CA (US); Corey Daniel Coolidge, Foothill Ranch, CA (US)

(73) Assignee: ASSA ABLOY Americas Residential Inc., New Haven, CT (US)

(21) Appl. No.: 18/806,129

(22) Filed: Aug. 15, 2024

Related U.S. Application Data
(60) Provisional application No. 63/519,752, filed on Aug. 15, 2023.

(51) Int. Cl. G07C 9/00

(52) U.S. Cl. CPC G07C 9/0069; G07C 9/00944; G07C 2009/00373; G07C 2009/00642

(57) ABSTRACT

An electronic lock is disclosed. The electronic lock may include components and perform methods for preserving battery power. In some embodiments, electrical components of the electronic lock are selectively activated and deactivated in response to interactions with a user, a mobile device, or server. In some embodiments, a battery is physically disconnected from a processor unless a user physically interacts with the electronic lock. In some embodiments, the electronic lock may wirelessly communicate with a mobile device and with a remote server.

### CROSS-REFERENCE TO RELATED APPLICATIONS

The present application claims priority from U.S. Provisional Patent Application No. 63/519,752 filed on Aug. 15, 2023, the disclosure of which is hereby incorporated by reference in its entirety.

### BACKGROUND

Some locks may include electrical components. For example, a lock may include electrical components for actuating a locking mechanism, communicating with other devices, communicating with users, storing data, or performing other functions. The electrical components consume power from a power source, typically a stored power source such as a battery. As a result, batteries for the electrical components must be charged or replaced to maintain certain functions of the lock. Monitoring, replacing, or charging electrical components may be a time-consuming or expensive task for a user. Additionally, a user may forget to charge or replace a battery.

### SUMMARY

In general, aspects of the present disclosure relate to an electronic lock with battery use mitigation. Electrical components of the electronic lock may be activated and deactivated in response to interactions with a user, mobile device, or server. In an example, electrical components are disconnected from a battery unless a user interacts with a component of the electronic lock. In some embodiments, the electronic lock may wirelessly communicate with the mobile device or a remote server.

In a first aspect, an electronic lock is disclosed. The electronic lock comprises a switch, a physically manipulatable component coupled to the switch, and an electrical circuit including a battery, a processor, and a keypad; wherein a movement of the physically manipulatable component by a user causes the switch to move from an open position to a closed position or from the closed position to the open position; wherein the switch, when in a closed position, activates the processor and keypad by closing the electrical circuit and electrically coupling the battery to the processor and the keypad; wherein the switch, when in an open position, deactivates the processor and keypad by opening the electrical circuit and electrically disconnecting the battery from the processor and the keypad; and wherein the processor, when activated, is configured to: receive a code via the keypad; validate the code; and in response to validating the code, actuate a bolt.

In a second aspect, a power-saving electronic lock is disclosed. The lock comprises a processor and a memory storing instruction that, when executed by the processor, cause the power-saving electronic lock to: detect a first input; based on the detection of the first input, activate an electrical component of the electronic lock; receive a code; validate the code; in response to validating the code, actuate a bolt to move the electronic lock from a locked state to an unlocked state or from the unlocked state to the locked state; detect a second input; and based on the detection of the detection of the second input, deactivate the electrical component of the electronic lock.

In a third aspect, an electronic lock with battery use mitigation is disclosed. The electronic lock comprises a processor and a memory storing instruction that, when executed by the processor, cause the electronic lock to: detect a first input, the first input being one or more of a physical manipulation of a component of the electronic lock, a communication received via a low-power network interface, a communication received via a high-power network interface, a detected location of a mobile device, a detection that the mobile device exited a geofence, a connection status of the mobile device, a determination that an electrical component is scheduled to be active, a determination that a battery life is above a threshold, detected locations of a plurality of registered users or paired users, connection statuses of the plurality of registered users or paired users, an actuation of the electronic lock using a physical key, or data from a video camera or a sensor; based on the detection of the first input, activate an electrical component of the electronic lock, the electrical component being one or more of a processor, a memory, a keypad, a motor, the low-power network interface, the high-power network interface, the sensor, or the camera; receive a code, the code being received via a keypad or via a wireless connection with the mobile device; validate the code; in response to validating the code, actuate a bolt to move the electronic lock from a locked state to an unlocked state or from the unlocked state to the locked state; detect a second input, the second input being one or more of a movement of the component of the electronic lock, a second communication received via the low-power network interface, a second communication received via the high-power network interface, a second detected location of the mobile device, a detection that the mobile device entered the geofence, a second connection status of the mobile device, a determination that the electrical component is scheduled to be deactivated, a determination that the battery life is below the threshold, second detected locations of the plurality of registered users or paired users, second connection statuses of the plurality of registered users or paired users, a second actuation of the electronic lock using the physical key, second data from the video camera or the sensor, or an expiration of a timer or a time delay; and based on the detection of the second input, deactivate the electrical component of the electronic lock, wherein deactivating the electrical component comprises one or more of disconnecting the electrical component from a power source, powering off the electrical component, or putting the electrical component in a low-power mode; wherein activating the electrical component comprises closing a mechanical switch or an electrical switch to connect the electrical component with a power source.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an environment including an electronic lock in which aspects of the present disclosure may be implemented.

FIG. 2 illustrates an environment including an electronic lock in which aspects of the present disclosure may be implemented.

FIG. 3 illustrates a side view of a portion of an electronic lock usable within the environments of FIGS. 1 and 2.

FIG. 4 illustrates a rear perspective view of a portion of an electronic lock usable within the environments of FIGS. 1 and 2.

FIG. 5 illustrates a front perspective view of a portion of an electronic lock usable within the environments of FIGS. 1 and 2.

FIG. 6 illustrates a front perspective view of a portion of an electronic lock usable within the environments of FIGS. 1 and 2.

FIG. 7 illustrates a schematic representation of an electronic lock, in accordance with aspects of the present disclosure.

FIG. 8 illustrates a schematic representation of an electronic lock, in accordance with further example aspects of the present disclosure.

FIG. 9 illustrates a schematic representation of a mobile device seen in the environment of FIG. 2.

FIG. 10 is a flowchart of a method for managing lock component activation in response to a physical input, according to an example embodiment.

FIG. 11 is a flowchart of a method for managing lock component activation in response to a physical input, according to an example embodiment.

FIG. 12 is a flowchart of a method for managing lock component activation in response to a lock actuation, according to an example embodiment.

FIG. 13 is a flowchart of a method for managing lock component activation in response to a communication via a low-power network interface, according to an example embodiment.

FIG. 14 is a flowchart of a method for managing lock component activation in response to a communication via a low-power network interface, according to an example embodiment.

FIG. 15 is a flowchart of a method for managing lock component activation based on an activation schedule, according to an example embodiment.

FIG. 16 is a flowchart of a method for managing lock component activation based on a battery life, according to an example embodiment.

FIG. 17 is a flowchart of a method for managing lock component activation based on camera data, according to an example embodiment.

FIG. 18 is a flowchart of a method for managing lock component activation based on device connection status, according to an example embodiment.

FIG. 19 is a flowchart of a method for managing lock component activation based on device location, according to an example embodiment.

FIG. 20 is a diagram of operations that may be performed by an electronic lock, according to an example embodiment.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

As briefly described above, embodiments of the present invention relate to mitigating battery use in an electronic lock. In some embodiments, circuitry of the lock is not connected until a user mechanically interacts with the lock, thereby connecting the circuitry and allowing the user to utilize electrical functions of the lock. In some embodiments, the electronic lock may mitigate battery use even if a circuit connecting the battery to other components remains closed. For example, in response to determining that a component that requires electrical power may not be needed, the electronic lock may disable the component or put the component into a low power mode. In some embodiments, the electronic lock may selectively activate and deactivate low-power and high-power network interfaces to preserve battery power.

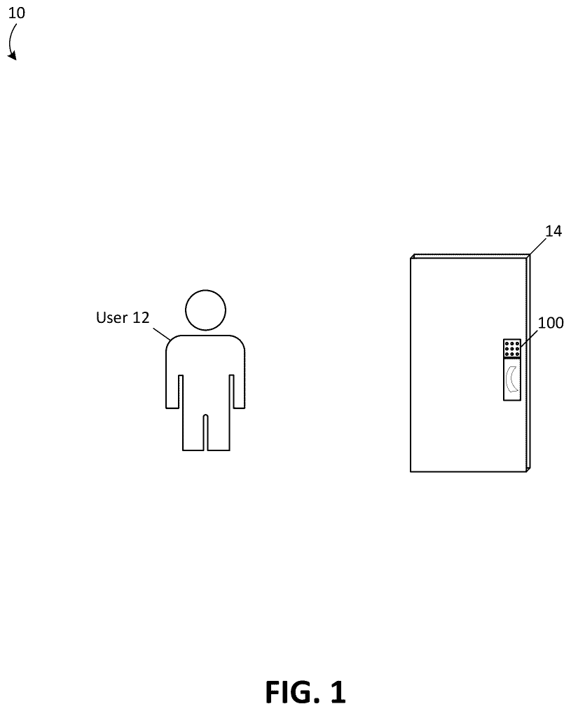

FIG. 1 illustrates an environment 10 in which aspects of the present disclosure may be implemented. A door 14 comprising an electronic lock 100 (also referred to as a wireless electronic lock) is installed at a premises. In some embodiments, the electronic lock 100 may include wireless communication capabilities. For example, the electronic lock 100 may include components for communicating with a user 12. In some embodiments, the electronic lock 100 may not include wireless communication capabilities. In particular, in some embodiments, electronic lock 100 may lack any communication capabilities, and its electronics are limited to actuation of a motor for lock operation locally.

A user 12 may interact with the electronic lock 100 to, for example, actuate a locking mechanism, check a status of the lock, update a lock setting, or perform another operation related to the lock. In some instances, the user 12 may be registered with the electronic lock 100 or may otherwise be authorized to actuate the electronic lock 100, such as an owner or tenant of the premises where the door 14 comprising the electronic lock 100 is installed. In some instances, the user 12 may have a code that he or she may enter at a keypad of the electronic lock 100 to actuate the locking mechanism, either in addition to or to the exclusion of the user being otherwise registered or authorized at the electronic lock (e.g., via connectivity between a mobile device of the user and the electronic lock).

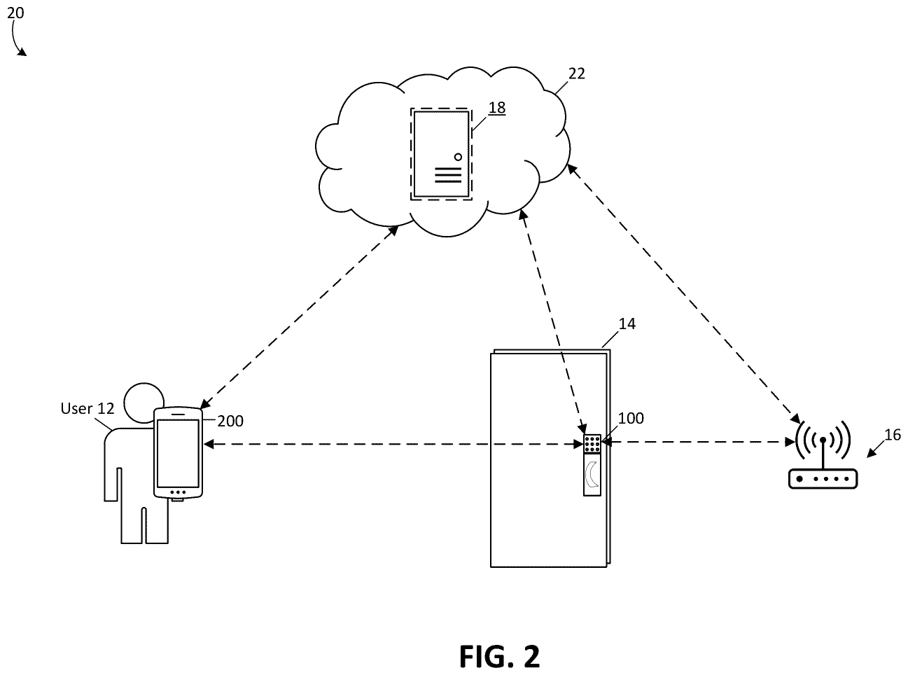

FIG. 2 illustrates a alternative environment 20 in which aspects of the present disclosure may be implemented. The environment 20 includes the user 12, a mobile device 200, the door 14, the electronic lock 100, a wireless router 16, and a server 18.

In the example shown, the user 12 may be associated with the mobile device 200. For example, the user 12 may carry the mobile device 200 or be the owner of the mobile device 200. The mobile device 200 may be a device with wireless communication capabilities, such as a smartphone, tablet, or key fob. The mobile device 200 may be capable of communicating with the electronic lock 100, communicating with the server 18, communicating with other mobile devices, and communicating with the router 16. The mobile device 200 may have a mobile application installed thereon that is associated with the electronic lock 100 or the server 18. The mobile device 200 may include a web browser for accessing a program to communicate with the electronic lock 100 or the server 18.

The server 18 can be, for example, a physical server or a virtual server hosted on a cloud platform 22. In examples, the cloud platform 22 may be a multi-cloud platform, a private cloud, a public cloud, or a hybrid cloud. In some embodiments, the server 18 may include a cluster of servers or nodes. In some embodiments, the electronic lock 100 is also capable of communicating 28 with the server 18. Such communication can optionally occur via one or more wireless communication protocols, e.g., Wi-Fi (IEEE 802.11), short-range wireless communication to a Wi-Fi bridge, or other connection mechanism. According to an embodiment, the server 18 may create and store an account associated with one or more of the electronic lock 100, the user 12, the mobile device 200, the router 16, the door 14, or the building on which the door 14 is installed. In some embodiments, the server 18 may create or store credentials for one or more of the accounts.

The router 16 may be a Wi-Fi router. In some embodiments, the router 16 be located within the premises or building to which the door 14 is attached. The router 16 may be capable of communicating with the electronic lock, and the router 16 may be capable of communicating with the server 18. The router 16 may route communications between the server 18 and the electronic lock 100. In some embodiments, the router may be a hub for Internet of Things (IoT) devices. In some embodiments, the electronic lock 100 and the router 16 may be coupled via a mesh network. For instance, communication between the electronic lock 100 and the router 16 may be passed through one or more other devices.

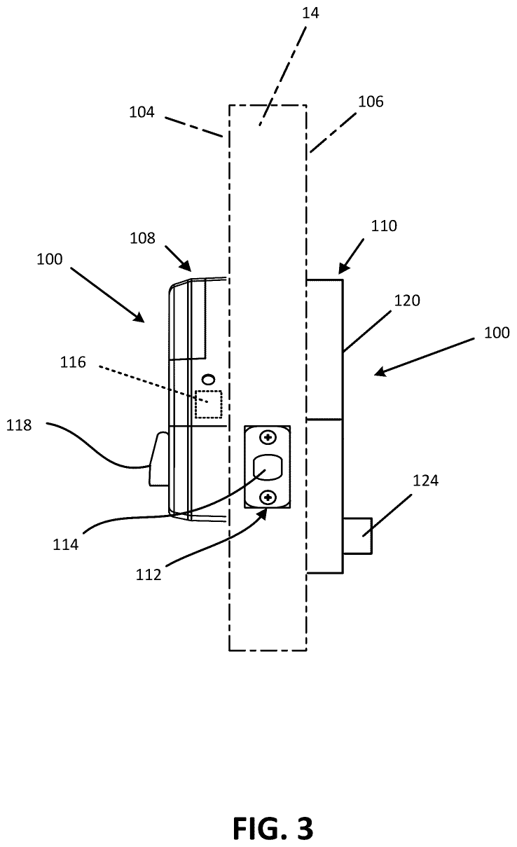

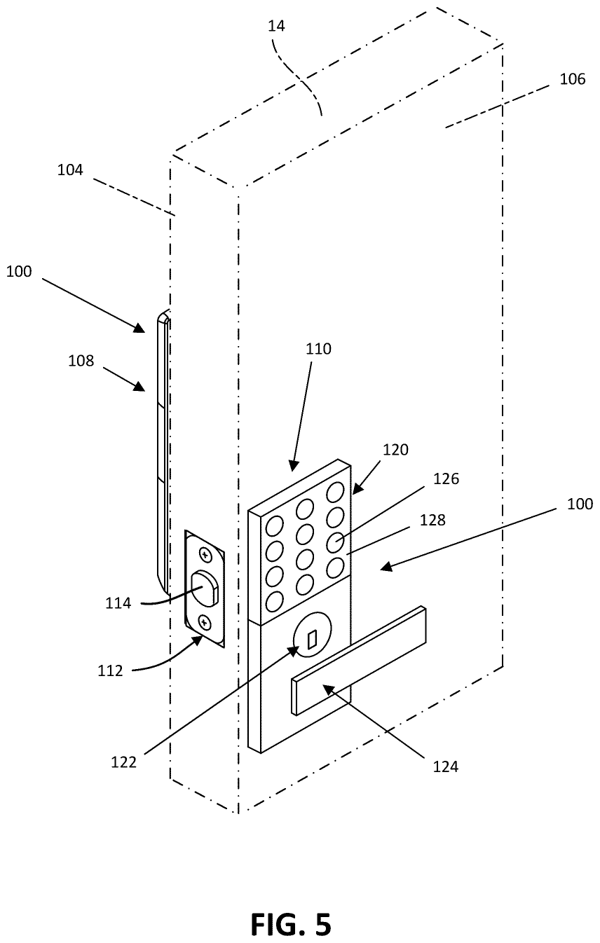

Referring to FIGS. 3-8 generally, in example embodiments, the electronic lock 100 may be used on both interior and exterior doors. Described below are non-limiting examples of a wireless electronic lock. It should be noted that the electronic lock 100 may be used on other types of doors, such as a garage door or a doggie door, or other types of doors that require an authentication process to unlock (or lock) the door.

FIGS. 3-6 illustrate an electronic lock 100 as installed at a door 14, according to one example of the present disclosure. The door 14 has an interior side 104 and an exterior side 106. The electronic lock 100 includes an interior assembly 108, an exterior assembly 110, and a latch assembly 112. The latch assembly 112 is shown to include a bolt 114 that is movable between an extended position (locked) and a retracted position (unlocked, shown in FIGS. 3-6). Specifically, the bolt 114 is configured to slide longitudinally and, when the bolt 114 is retracted, the door 14 is in an unlocked state. When the bolt 114 is extended, the bolt 114 protrudes from the door 14 into a doorjamb (not shown) to place the door in a locked state. In examples, a processor of the electronic lock 100 may use a motor to actuate the bolt 114.

In some examples, the interior assembly 108 is mounted to the interior side 104 of the door 14, and the exterior assembly 110 is mounted to the exterior side 106 of the door 14. The latch assembly 112 is typically at least partially mounted in a bore formed in the door 14. The term “outside” is broadly used to mean an area outside the door 14 and “inside” is broadly used to denote an area inside the door 14. With an exterior entry door, for example, the exterior assembly 110 may be mounted outside a building, while the interior assembly 108 may be mounted inside a building. With an interior door, the exterior assembly 110 may be mounted inside a building, but outside a room secured by the electronic lock 100, and the interior assembly 108 may be mounted inside the secured room. The electronic lock 100 is applicable to both interior and exterior doors.

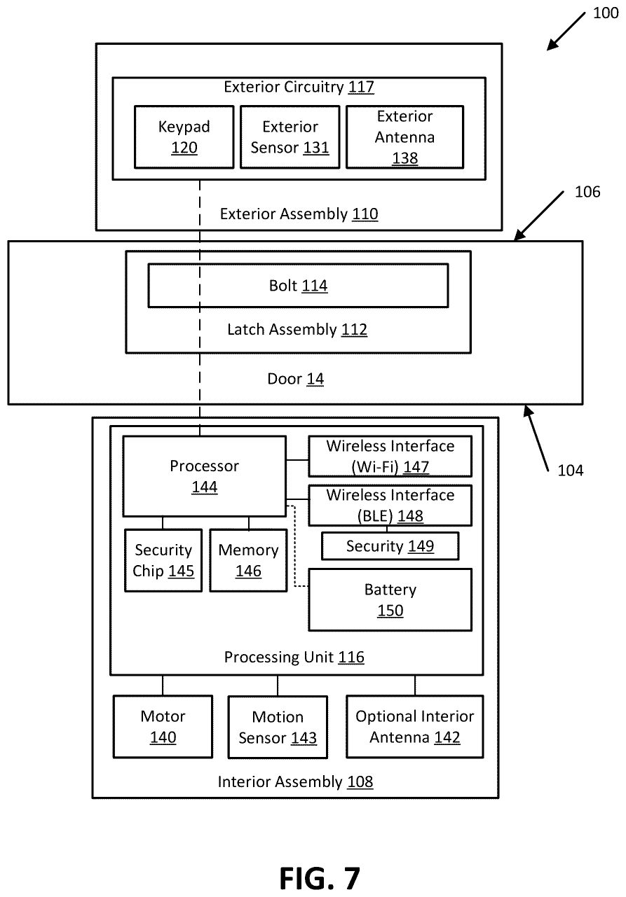

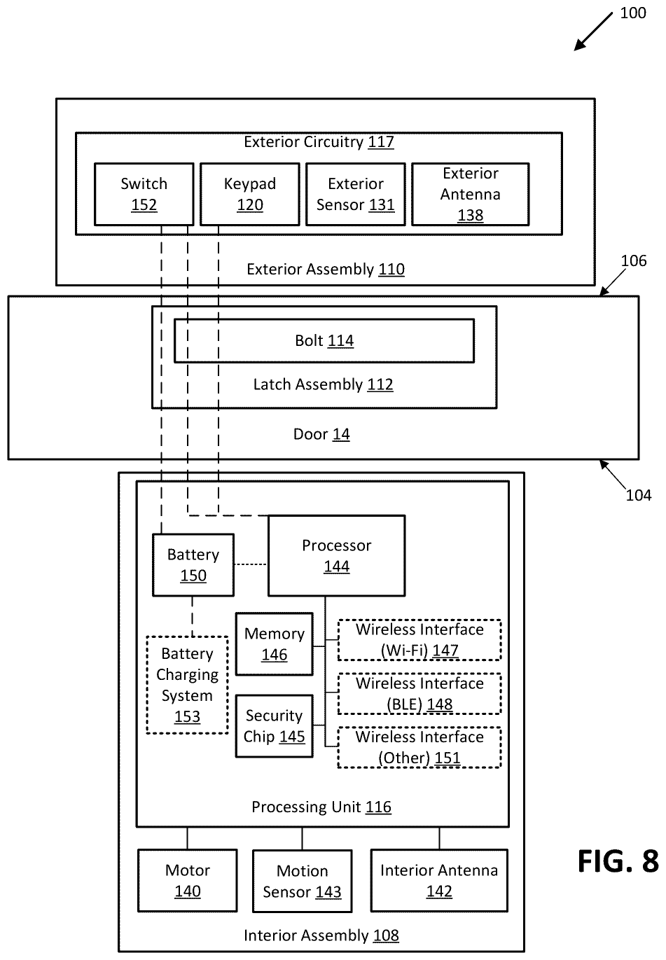

In some embodiments, the interior assembly 108 can include a processing unit 116 (shown schematically in FIGS. 7-8) containing electronic circuitry for the electronic lock 100. In some examples, the interior assembly 108 includes a manual turn piece 118 that can be used on the interior side 104 of door 14 to move the bolt 114 between the extended and retracted positions. The processing unit 116 is operable to execute a plurality of software instructions (e.g., firmware) that, when executed by the processing unit 116, cause the electronic lock 100 to implement the methods and otherwise operate and have functionality as described herein. The processing unit 116 may comprise a device commonly referred to as a processor, e.g., a central processing unit (CPU), digital signal processor (DSP), or other similar device, and may be embodied as a standalone unit or as a device shared with components of the electronic lock 100. The processing unit 116 may include memory communicatively interfaced to the processor for storing the software instructions. Alternatively, the electronic lock 100 may further comprise a separate memory device for storing the software instructions that is electrically connected to the processing unit 116 for the bi-directional communication of the instructions, data, and signals therebetween.

In some examples, the interior assembly 108 includes a pairing button 119 (shown schematically), which when actuated, initiates a pairing mode for a connection over an interface. For example, the pairing mode may enable the electronic lock 100 to communicate with a mobile device (e.g., the mobile device 200) within wireless communication range for enabling the mobile device to be paired with the electronic lock 100. As can be appreciated, initiating the pairing mode via an actuation of the pairing button 119 may be limited to users who have access to the interior side 104 of the door 14. In some embodiments, the electronic lock 100 may be coupled with a mobile device without use of the pairing button 119. For instance, pairing may be performed by communicating with the server 18, or one or more of the mobile device 200 or the electronic lock 100 may broadcast a signal for pairing.

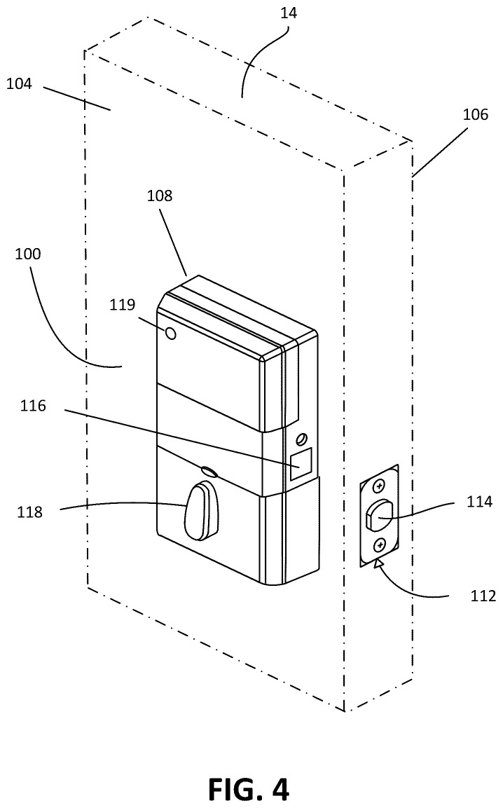

Referring to FIG. 4, the exterior assembly 110 can include exterior circuitry 117 communicatively and electrically connected to the processing unit 116. For example, the exterior assembly 110 can include a keypad 120 for receiving a user input and/or a keyway 122 for receiving a key (not shown). The exterior side 106 of the door 14 can also include a handle 124. In some examples, the exterior assembly 110 includes the keypad 120 and not the keyway 122. In some examples, the exterior assembly 110 includes the keyway 122 and not the keypad 120. In some examples, the exterior assembly 110 includes the keyway 122 and the keypad 120. When a valid key is inserted into the keyway 122, the valid key can move the bolt 114 between the extended and retracted positions. When a user inputs a valid actuation passcode into the keypad 120, the bolt 114 may be moved between the extended and retracted positions. In some examples, the exterior assembly 110 is electrically connected to the interior assembly 108. Specifically, in some examples, the keypad 120 may be electrically connected to the interior assembly 108, specifically to the processing unit 116, by, for example, an electrical cable (not shown) that passes through the door 14. When the user inputs a valid actuation passcode via the keypad 120 that is recognized by the processing unit 116, an electrical motor is energized to retract the bolt 114 of latch assembly 112, thus permitting door 14 to be opened from a closed position. Still further, an electrical connection between the exterior assembly 110 and the interior assembly 108 allows the processing unit 116 to communicate with other features included in the exterior assembly 110, as noted below. In some embodiments, however, one or more electrical components of the electronic lock 100 may not be active until a user interacts with the electronic lockset 100. As a result, battery power may be conserved until an electrical component or function is needed.

The keypad 120 can be any of a variety of different types of keypads. The keypad 120 can be one of a numeric keypad, an alpha keypad, and/or an alphanumeric keypad. The keypad 120 can have a plurality of characters displayed thereon. For example, the keypad 120 can include a plurality of buttons 126 that can be mechanically actuated by the user (e.g., physically pressed). In some examples, the keypad 120 includes a touch interface 128, such as a touch screen or a touch keypad, for receiving a user input. The touch interface 128 is configured to detect a user's “press of a button” by contact without the need for pressure or mechanical actuation. In some embodiments, interacting with the keypad 120 may cause an electrical component of the electronic lock 100 to be activated (e.g., may cause a switch to close), which may allow the user to actuate the bolt 114 using the keypad 120.

In alternative embodiments, one or more other types of user interface devices can be incorporated into the electronic lock 100. For example, in example implementations, the exterior assembly 110 can include a biometric interface (e.g., a fingerprint sensor, retina scanner, or camera including facial recognition), or an audio interface by which voice recognition could be used to actuate the lock. Still further, other touch interfaces may be implemented, e.g., where a single touch may be used to actuate the lock rather than requiring entry of a specified actuation passcode.

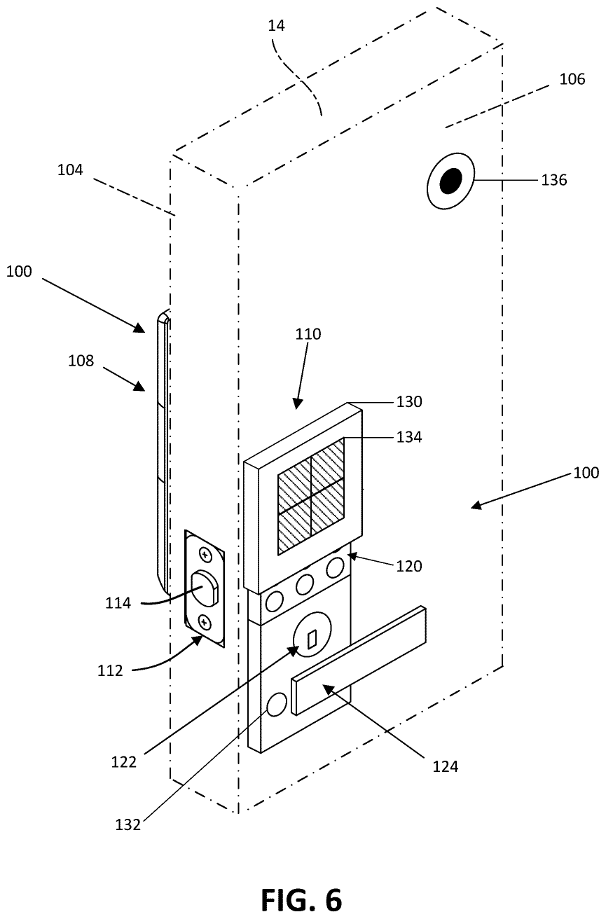

Referring to FIG. 6, the electronic lock may include a physically manipulatable component, such as a cover 130 or button 132. Other examples of physically manipulatable components may include the handle 124, parts of the keypad 120, a toggle or switch, a lever, a sensor, or another component. In examples, the physically manipulatable component may be moved, touched, pressed, or otherwise interacted with by a user. As shown in the example of FIG. 6, the cover 130 may be part of the exterior assembly 110. In some embodiments, the cover 130 may be configured to slide from an open position to a closed position, and vice-versa. When in an open position, the cover 130 may expose the keypad 120. When in a closed position, the cover 130 may cover the keypad 120. In some embodiments, a user may apply a force to move the cover from the closed position to the open position, or vice-versa. In some embodiments, a default position of the cover 130 (e.g., without an applied force from a user) may be a closed position.

In some embodiments, when the cover 130 is in an open position, circuitry of the electronic lock may be connected or closed. For instance, the cover 130 may actuate a switch thereby closing an electrical circuit. When the circuit is closed, a battery may provide power to a controller or processing unit (e.g., a battery 150 may provide power to a processor 144). When the circuit is not closed, the battery may not be providing power to a controller or processing unit; as a result, the battery may be conserving power. Thus, when a user slides the cover 130 from a closed position to an open position, not only does the user expose the keypad 120, but the user may also activate electronic functions of the electronic lock 100 (such as the keypad 120 or a network communication interface), thereby enabling use of the keypad 120 to actuate the bolt 114. Furthermore, when the cover 130 is closed, which may be a default state of the cover 130, a component of the electronic lock 100 may be deactivated and battery usc may be mitigated, and battery longevity may be extended.

In some embodiments, the electronic lock 100 may include an activation button 132, which may be another example of a physically manipulatable component, disposed on the exterior assembly 110. Actuating the activation button 132 may activate one or more electrical components of the electronic lock 100. For instance, the activation button 132 may be coupled to a switch 152. A user may press or touch the activation button 132, and in response, the activation button 132 may cause an electrical circuit of the electronic lock 100 to close. As a result, the keypad 120 may then be used by the user to actuate the bolt 114. In some embodiments, when the activation button 132 is not pressed, then the switch may not be closed, and the battery 150 may not provide power to the controller or processor. In some embodiments, the switch may be closed for an amount of time (e.g., 5 seconds, 10 seconds, 1 minute, etc.) after the activation button 132 is pressed or touched, thereby giving the user an amount of time to enter a code into the keypad 120 and to actuate the latch assembly 112. Once that time has elapsed, the switch may be opened, and the battery 150 may not provide power to the controller or processor, thereby saving power and extending battery life.

In some embodiments, the electronic lock 100 may include a solar panel 134. The solar panel 134 may be fixed to the exterior assembly 110, and a surface of the solar panel 134 may be exposed on a surface of the exterior assembly 110. In some embodiments, the solar panel 134 may be attached to the cover 130. In some embodiments, the solar panel 134 may be electrically coupled to the electronic lock 100 but may be located elsewhere, such as a roof, a wall, a detached stand, a different part of the door 14, or another location. In some embodiments, the solar panel 134 may include multiple solar panels located in different locations. In some embodiments, the solar panel 134 may charge one or more components of the electronic lock 100, such as the battery 150.

In some embodiments, the electronic lock 100 may be coupled to a camera 136. In some embodiments, the camera 136 may be disposed on the exterior side 106 of the door 14. In some embodiments, the camera 136 may be activated by a processing unit of the electronic lock 100. In some embodiments, the camera 136 may detect movement (e.g., a user approaching the door 14). In response to detecting movement, the camera 136 may provide a signal to the electronic lock 100, thereby activating or deactivating a component of the electronic lock 100. For example, in response to detecting that a user is leaving a premises, the camera 136 may provide a signal to electronic lock 100, which may, in response, activate a network interface so that the user may wirelessly communicate with the electronic lock 100 using the mobile device 200.

FIGS. 7-8 illustrate schematic representations of embodiments of the electronic lock 100 mounted to the door 14. Examples of the interior assembly 108, the exterior assembly 110, and the latch assembly 112 are shown. In other embodiments, the electronic lock 100 may include more or fewer components than those illustrated in connection with the FIGS. 7-8. In some embodiments, the electronic lock 100 may include an electrical circuit that connects one or more components of the electronic lock 100 described herein. In examples, the electrical circuit may receive power from the battery 150 or from a different power source. In some embodiments, the electronic lock 100 may include a plurality of subcircuits, each of which may include one or more components of the electronic lock 100 described herein, and the subcircuits may, in some embodiments, allow the electronic lock 100 to selectively activate or deactivate only some electrical components.

The exterior assembly 110 is shown to include exterior circuitry, the keypad 120, and an exterior antenna 138 usable for communication with a remote device. In addition, the exterior assembly 110 can include one or more sensors 131, such as a camera, proximity sensor, button, or other mechanism by which conditions exterior to the door 14 can be sensed. In response to such sensed conditions, notifications may be sent by the electronic lock 100 to a server 18 or mobile device 200 including information associated with a sensed event (e.g., time and description of the sensed event, or remote feed of sensor data obtained via the sensor).

The exterior antenna 138 is capable of being used in conjunction with an interior antenna 142, such that the processing unit 116 can determine where a mobile device is located. In some embodiments, only a mobile device (e.g., the mobile device 200) that is paired with the electronic lock 100 and determined to be located on the exterior of the door 14 is able to actuate (unlock or lock) the door. This prevents unauthorized users from being located exterior to the door 14 of the electronic lock 100 and taking advantage of an authorized mobile device that may be located on the interior of the door, even though that authorized mobile device is not being used to actuate the door. In alternative arrangements, the electronic lock 100 is only actuatable from either the keypad 120 (via entry of a valid actuation passcode) or from an application installed on a mobile device.

As described above, the interior assembly 108 includes the processing unit 116. The interior assembly 108 can also include a motor 140, a motion sensor 143, and an interior antenna 142. As shown, the processing unit 116 includes at least one processor 144 communicatively connected to a security chip 145, a memory 146, various wireless network interfaces, and a battery 150. For example, the processing unit 116 may include a network interface for communicating via the IEEE 802.11 standard (Wi-Fi®), the IEEE 802.15.4 standard (Zigbee®, Z-Wave®, and Thread), the IEEE 802.15.1 standard (Bluetooth®), or another standard. In some embodiments a Bluetooth interface 148 may be configured to communicate via a Bluetooth Low Energy (BLE) protocol. In some embodiments, the BLE interface 148 may be coupled with a security module 149. In some embodiments, a network interface for communicating via other communication protocols may be present, instead of, or in addition to, a Wi-Fi interface 147 and the BLE interface 148. For example, the electronic lockset 100 may include a network interface for communicating according to one or more of the following protocols: Thread, Matter, near-field communication (NFC), Z-Wave, ZigBee, Narrow Band IoT (NB-IoT), LoRa, 3G, LTE, 4G, 5G, or another protocol or network. The processing unit 116 is located within the interior assembly 108 and is capable of operating the electronic lock 100, e.g., by actuating the motor 140 to actuate the bolt 114.

In some examples, the processor 144 can process signals received from a variety of devices to determine whether the electronic lock 100 should be actuated. Such processing can be based on a set of preprogramed instructions (i.e., firmware) stored in the memory 146. In certain embodiments, the processing unit 116 can include a plurality of processors 144, including one or more general purpose or specific purpose instruction processors. In some examples, the processing unit 116 is configured to capture a keypad input event from a user and store the keypad input event in the memory 146. In other examples, the processor 144 receives a signal from the exterior antenna 138, the interior antenna 142, or a motion sensor 143 (e.g., a vibration sensor, gyroscope, accelerometer, motion/position sensor, or combination thereof) and can validate received signals in order to actuate the lock 100. In still other examples, the processor 144 receives signals from one or more network interfaces to determine whether to actuate the electronic lock 100.

In some embodiments, the processing unit 116 includes a security chip 145 that is communicatively interconnected with one or more instances of processor 144. The security chip 145 can, for example, generate and store cryptographic information usable to generate a certificate usable to validate the electronic lock 100 with a remote system, such as the server 18 or mobile device (e.g., the mobile device 200). In certain embodiments, the security chip 145 includes a one-time write function in which a portion of memory of the security chip 145 can be written only once, and then locked. Such memory can be used, for example, to store cryptographic information derived from characteristics of the electronic lock 100, or its communication channels with server 18 or one or more mobile devices 200. Accordingly, once written, such cryptographic information can be used in a certificate generation process which ensures that, if any of the characteristics reflected in the cryptographic information are changed, the certificate that is generated by the security chip 145 would become invalid, and thereby render the electronic lock 100 unable to perform various functions, such as communicate with the server 18 or mobile device 200, or operate at all, in some cases.

In some embodiments, the security chip 145 may be configured to generate a pairing passcode that, when entered using the keypad 120 of the electronic lock 100, triggers a pairing mode of one or more of the network interfaces of the electronic lock 100 that enables the electronic lock 100 to pair with a proximate mobile device. In some embodiments, a pairing passcode may be used to pair with a proximate mobile device. In some examples, the pairing passcode is provided to the user 12 upon initial setup/activation of the electronic lock 100 (e.g., via an electronic lock application associated with the electronic lock 100 operating on the mobile device 200). In some examples, the pairing passcode is a random value. In some examples, the user 12 may be enabled to change the pairing passcode by setting their own code or by requesting a random value to be generated by the electronic lock application operating on the mobile device 200. In some examples, the length of the pairing passcode is variable. According to an aspect, for increased security, the pairing passcode may be a limited-use passcode. For example, the pairing passcode may be limited to a single use or may be active for a preset or administrative user-selected time duration. In further examples, a digit of the pairing passcode may correspond to a setting that may instruct the electronic lock 100 to perform one or more of: disable the pairing passcode after it has been used; keep the pairing passcode enabled after it has been used; or reset the pairing passcode to a new random value after it has been used.

The memory 146 can include any of a variety of memory devices, such as using various types of computer-readable or computer storage media. A computer storage medium or computer-readable medium may be any medium that can store a program or instructions for performing one or more operations, steps, or methods described herein. By way of example, computer storage media may include dynamic random access memory (DRAM) or variants thereof, solid state memory, read-only memory (ROM), electrically erasable programmable ROM, and other types of devices and/or articles of manufacture that store data. Computer storage media generally includes at least one or more tangible media or devices. Computer storage media can, in some examples, include embodiments including entirely non-transitory components. In some embodiments, the processor 144 may execute programs or instructions stored by the memory 146. In some embodiments, the memory 146 may store one or more codes that may be input by a user to actuate the bolt 114. For instance, a user may input a code into the keypad 120, or the mobile device 200 may provide a code to the electronic lock 100 via a network interface. To validate the code, the processor 144 may compare the input code to the one or more codes stored in the memory 146.

As noted above, the processing unit 116 can include one or more wireless interfaces, such as Wi-Fi interface 147, a Bluetooth interface 148, and/or another interface. Other RF circuits can be included as well. In the example shown, the interfaces 147, 148 are capable of communication using at least one wireless communication protocol. In some examples, the processing unit 116 can communicate with a remote device, such as the server 18, via a first network interface (e.g., the Wi-Fi interface 147) and with a proximate device, such as the mobile device 200, via a second network interface (e.g., the interface 148 or 151). In some embodiments, the processing unit 116 is configured to communicate with the mobile device 200 via a short-range wireless interface, such as a network interface configured to communicate using a protocol for any one or more of BLE, NFC, Thread, or another protocol. When the mobile device 200 is out of range of such network, the mobile device 200 may communicate with the server 18, which may relay communications to the electronic lock 100. In some embodiments, the electronic lock 100 may use the Wi-Fi interface 147 to communicate with the server 18. In other embodiments, the electronic lock 100 may communicate with a hub device or router device using a different network protocol (e.g., BLE, NFC, Thread), and the hub device or router may route communications between the server 18 and the electronic lock 100.

In some embodiments, the BLE interface 148 is an example of a low-power network interface. Other examples of low-power network interfaces many include an interface for communicating via a near-field communication (NFC) protocol, a Thread protocol, a Z-Wave protocol, a ZigBee protocol, a Narrow Band IoT (NB-IoT) protocol, a LoRa protocol, or another protocol. In some embodiments, a low-power network interface may be a network interface that itself is not coupled to a power source, such as a passive NFC reader or other reader device. In some embodiments, a low-power network interface may be an interface that consumes less power than a Wi-Fi interface for performing a similar task over a similar amount of time as a Wi-Fi interface.

In some embodiments, the Wi-Fi interface 147 is an example of a high-power network interface. Other examples of high-power network interfaces in the electronic lock 100 may include an interface for communicating via one or more of 3G, LTE, 4G, or 5G. In some embodiments, the electronic lock 100 may prioritize communicating with a mobile device via low-power network interface over a high-power network interface. For instance, if the mobile device 200 is coupled to the electronic lock 100 via a high-power network interface and a low-power network interface, then the electronic lock 100 may be configured to communicate with the mobile device 200 via the low-power network interface. Examples of methods of prioritizing a particular wireless interface and/or protocol are described in co-pending U.S. Provisional Patent Application No. 63/519,736, entitled “ELECTRONIC LOCKSET HAVING MULTIPLE WIRELESS RADIOS”, filed Aug. 15, 2023, and having Attorney Docket No. 19480.0540USP1, the disclosure of which is incorporated by reference in its entirety. In some embodiments, the electronic lock 100 may disable the high-power network interface, as is further described below. Additionally, in some embodiments, the electronic lock 100 may deactivate one or more of the network interfaces to save battery power or in response to determining that the network interface may not be needed.

The interior assembly 108 also includes the battery 150 to power the electronic lock 100. In some embodiments, the electronic lock 100 may include a plurality of batteries, or the electronic lock 100 may also include other power sources. In one example, the battery 150 may be a standard single-use (disposable) battery. Alternatively, the battery 150 may be rechargeable. In some embodiments, the electronic lock 100 may include, or be coupled with, a battery charging system 153.

In some embodiments, the battery charging system 153 may include the solar panel 134. In such embodiments, the solar panel 134 may be positioned within an exterior assembly, but persistently electrically connected to other circuitry of a battery charging system 153 such that the battery may be recharged even when other components may be disconnected (e.g., as described below in conjunction with use of switch 152). In other embodiments, aspects of the battery charging system 153 may be included within the exterior assembly as well.

In some embodiments, the battery charging system 153 may include a signal harvesting device, such as a device for harvesting radio waves used for communicating over Wi-Fi or 5G. In such embodiments, these radio waves may be harvested and used to charge the battery 150. Examples methods of harvesting are described in U.S. Pat. No. 9,328,532, entitled “ELECTRONIC LOCKSET WITH MULTI-SOURCE ENERGY HARVESTING CIRCUIT”, the disclosure of which is hereby incorporated by reference in its entirety.

The interior assembly 108 also includes the motor 140 that is capable of actuating the bolt 114. In use, the motor 140 receives an actuation command from the processing unit 116, which causes the motor 140 to actuate the bolt 114 from the locked position to the unlocked position or from the unlocked position to the locked position. In some examples, the motor 140 actuates the bolt 114 to an opposing state. In some examples, the motor 140 receives a specified lock or unlock command, where the motor 140 only actuates the bolt 114 if the bolt 114 is in the correct position. For example, if the door 14 is locked and the motor 140 receives a lock command, then no action is taken. If the door 14 is locked and the motor 140 receives an unlock command, then the motor 140 actuates the bolt 114 to unlock the door 14. In some embodiments, a mechanism other than the motor 140 may be used to electrically actuate the bolt 114, such as magnets or solenoids.

As noted above, the interior antenna 142 may also be located in the interior assembly 108. In some examples, the interior antenna 142 may operate with the exterior antenna 138 to determine the location of a mobile device. In some examples, only a mobile device determined to be located on the exterior side 106 of the door 14 is able to unlock (or lock) the door 14. This prevents unauthorized users from being located near the electronic lock 100 and taking advantage of an authorized mobile device that may be located on the interior side 108 of the door 14, even though the authorized mobile device is not being used to unlock the door 14. In alternative embodiments, the interior antenna 142 can be excluded entirely, since the electronic lock 100 is actuated only by an authorized mobile device.

In the example of FIG. 8, one or more of the network interfaces 147, 148, or 151 may not be present. For example, in some embodiments, the electronic lock 100 may not have wireless communication capabilities, or the electronic lock 100 may only have an interface for communicating via either a low-power network interface or a high-power network interface. Additionally, in some embodiments, the electronic lock 100 may selectively activate and deactivate one or more of the network interfaces. For instance, the electronic lock 100 may deactivate a high-power network interface while keeping a low-power network interface active, or vice-versa.

Furthermore, in the example of FIG. 8, the electronic lock 100 includes the switch 152. As shown, the switch 152 may complete a circuit between the battery 150 and other components of the processing unit 116, such as the processor 144. When the switch 152 is in a closed position, the circuit may be closed and electrically couple components of the electronic lock 100. For example, when the circuit is closed, the battery 150 may provide power to other components of the processing unit 116. When the switch 152 is in an open position, the circuit may be open, and the processor 144 and other components of the electronic lock 100 may not be powered. For example, when open, the switch 152 may electrically disconnect components of the electronic lock 100. In some embodiments, a default position of the switch 152 may be open. For example, without an external force on the switch 152 or to a component coupled to the switch (e.g., a physically manipulatable component like the cover 130 or button 132), then the switch may be open. Without such a force, the switch 152 may, in some embodiments, revert to the open position. In some embodiments, a component coupled to the switch is configured such that the component forces the switch to the open position absent a force that moves the component.

In the example shown, the switch 152 is disposed in the exterior assembly 110. In other embodiments, the switch 152 may be located elsewhere, such as the interior assembly or outside of the electronic lock 100. In some embodiments, the switch 152 may be coupled to and actuated by another component of the electronic lock 100. Depending on the embodiment, the switch 152 may be a mechanical switch or an electrical switch. In some embodiments, there may be a plurality of switches for a plurality of subcircuits. Each of the subcircuits may couple a power source (e.g., the battery 150) with one or more electrical components, and the electronic lock 100 may be configured, using the plurality of switches, to activate some subcircuits but not others, thereby allowing the electronic lock 100 to selectively activate and deactivate electrical components.

In an example, the switch 152 may be coupled to the cover 130, such that when the cover 130 is open, the switch 152 is in a closed state, thereby allowing power to flow from the battery 150 to the processor 144, the keypad 120, and other components of the electronic locks 100. When the cover 130 is closed, the switch 152 may be open, thereby preserving power of the battery 150. As another example, the switch 152 may be coupled to the button 132, the handle 124, or the keypad 120, such that when one or more of these components is manipulated (e.g., pressed or touched), the switch 154 may be closed. In some embodiments, the switch may be coupled to a timer. The timer may be configured to determine an amount of time that the switch 154 is closed (e.g., 10 seconds, 1 minute, 5 minutes) before automatically opening. As a result, following an interaction with a component of the electronic lock 100 that closes the switch and activates one or more components of the electronic lock 100, the components may remain active for a certain amount of time before powering down.

In some embodiments, the electronic lock 100 is made of mixed metals and plastic, with engineered cavities to contain electronics and antennas. For example, in some embodiments, the lock utilizes an antenna near the exterior face of the lockset, designed inside the metal body of the lockset itself. The metal body can be engineered to meet strict physical security requirements and also allow an embedded front-facing antenna to propagate RF energy efficiently.

In still further example embodiments, the electronic lock 100 can include an integrated motion sensor 143. Using such a motion sensor (e.g., an accelerometer, gyroscope, or other position or motion sensor) and wireless capabilities of a mobile device or an electronic device (i.e., fob) with these capabilities embedded inside can assist in determining additional types of events (e.g., a door opening or door closing event, a lock actuation or lock position event, or a knock event based on vibration of the door). In some cases, motion events can cause the electronic lock 100 to perform certain processing, e.g., to communicatively connect to or transmit data to the mobile device 200 or the server 18 or to activate or deactivate an electrical component of the electronic lock 100.

In some embodiments, other lock actuation sequences may not require use of a motion sensor 143. For example, if the mobile device 200 is in valid range of the electronic lock 100 when using a particular wireless protocol, then a connection will be established with the electronic lock 100. Other arrangements are possible as well, using other connection sequences and/or communication protocols.

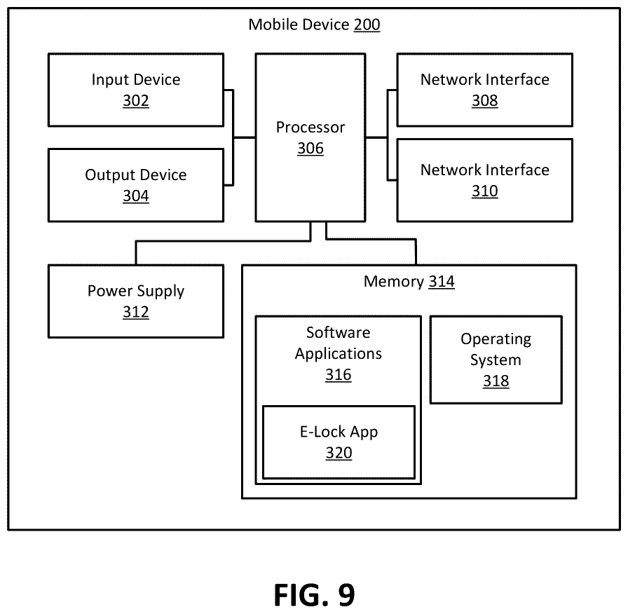

FIG. 9 illustrates a schematic diagram of a mobile device, such as the mobile device 200, usable in embodiments of the present disclosure. In some embodiments, the mobile device 200 operates to form a connection with a network enabled security device such as the electronic lock 100. In some embodiments, the mobile device 200 may communicate with the server 18 via a Wi-Fi or mobile data connection. Thus, in some embodiments, the mobile device 200 can operate to communicate information between the electronic lock 100 and the server 18. The mobile device 200 shown in FIG. 9 includes an input device 302, an output device 304, a processor 306, a first network interface 308, a second network interface 310, a power supply 312, and a memory 314. In some embodiments, the first network interface 308 may be a Wi-Fi interface, and the second network interface 310 may be a Bluetooth interface. In some embodiments, the mobile device 200 may include an interface to communicate via a cellular network, a Thread protocol, near-field communication protocol, or another protocol or network type.

The input device 302 operates to receive input from external sources. Such sources can include inputs received from a user (e.g., the user 12). The inputs can be received through a touchscreen, a stylus, or a keyboard. In some embodiments, the input device may receive a voice input.

The output device 304 operates to provide output of information from the mobile device 200. For example, a display can output visual information while a speaker can output audio information.

The processor 306 reads data and instructions. The data and instructions can be stored locally, received from an external source, or accessed from removable media. In some examples, the first network interface 308 is similar to the Wi-Fi interface 147. In some embodiments, a Wi-Fi connection may be established between the mobile device 200 and the server 18. In some embodiments, a connection via a cellular network may be established between the mobile device 200 and the server 18. In some embodiments, the second network interface 310 is similar to the Bluetooth interface 148. In some examples, a Bluetooth connection may be established between the mobile device 200 and the electronic lock 100. In some embodiments, a connection according to an NFC protocol, Thread protocol, or other protocol may be established between the mobile device 200 and the electronic lock 100.

The power supply 312 provides power to the processor 306. The memory 314 includes software applications 316 and an operating system 318. The memory 314 contains data and instructions that are usable by the processor to implement various functions of the mobile device 200.

The software applications 316 can include applications usable to perform various functions on the mobile device 200. One such application is an electronic lock application 320. In some embodiments, the electronic lock application 320 may be used to interact with the electronic lock 100. In some embodiments, the electronic lock application 320 may be used to interact with the server 18. In other embodiments, the mobile device 200 may include more or fewer components than those illustrated in the example of FIG. 9.

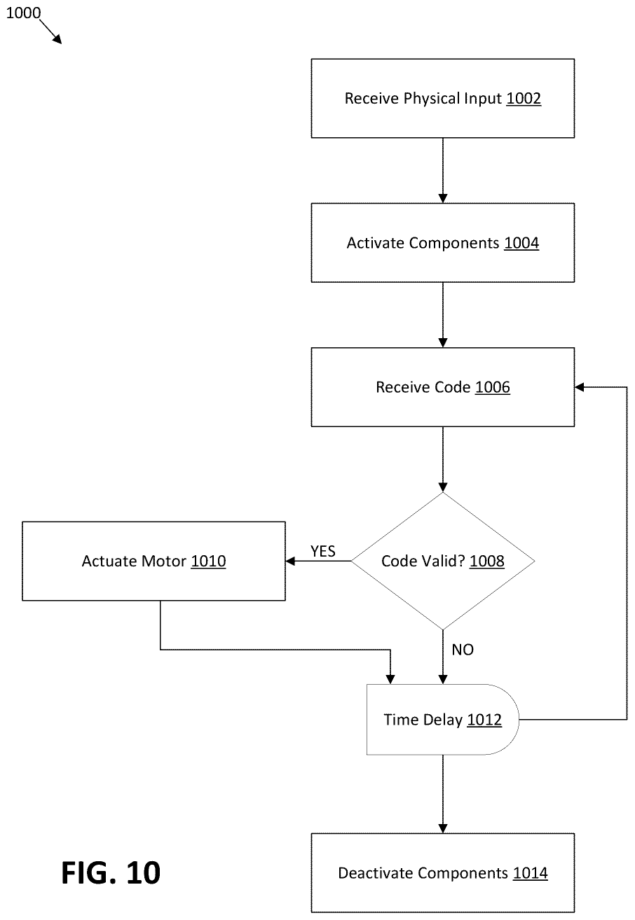

FIGS. 10-20 illustrate flowcharts for performing aspects of the present disclosure. The methods illustrated in the FIGS. 10-20 may, in some instances, mitigate power expenditure of components of the electronic lock 100, thereby extending, in some instances, battery life of the electronic lock 100. In describing the FIGS. 10-20, the methods are described as being performed by the electronic lock 100, which may encompass components of the electronic lock 100, such as the processor 144. However, in some embodiments, aspects of the methods described in connection with the FIGS. 10-20 may be performed by components or entities other than the electronic lock 100, such as the mobile device 200, the server 18, or another device or system. Furthermore, in some embodiments, operations described in connection with the FIGS. 10-20 may be combined. For example, one or more operations described in connection with a first method may be used in a different method. In some embodiments, some operations described in connection with the FIGS. 10-20 may be optional.

FIG. 10 is a flowchart of a method 1000. In the example of FIG. 10, circuitry of the electronic lock 100 may be connected by a physical input of a user (e.g., physically manipulating a component of the electronic lock 100 by sliding a cover or pushing a button to physically close an electrical circuit). Once the circuit is closed, a battery of the electronic lock 100 may provide power to a processor. The processor may, in response to a correct code being received from a keypad, actuate a lock. Without the user's physical input, circuitry of the electronic lock 100 may be disconnected, resulting in battery power being saved. In some embodiments, the electronic lock 100 in the example of FIG. 10 may not include wireless communication capabilities

In the example shown, the electronic lock 100 may receive a physical input (step 1002). The physical input may be from a human user on an interior or exterior side of the lock. The form of the physical input may vary. The user may apply a force to a physically manipulatable component of the electronic lock 100. For example, the user may slide the cover 130 of the electronic lock 100. In some embodiments, the user may press or touch a button 132. In some embodiments, the user may insert a key or other object into an aperture of the electronic lock 100. In some embodiments, the user may interact with a physical component that is located apart from the electronic lock (e.g., a button or manipulatable object that is located apart from the electronic lock).

In the example shown, the electronic lock 100 may activate components (step 1004). Depending on the embodiment, activating components may include mechanically or electrically connecting one or more electrical circuits in the lock or may include using a processor to change a power state of one or more components. In some embodiments, when a component is active, it may be in a regular power state in which the component is fully operable, and when the component is deactivated, it may be in a no power state (e.g., the component may be electrically disconnected form a power source) or a low power state.

In the example of FIG. 10, the user's physical input may cause a switch of the electronic lock 100 to close, thereby closing and activating an electronic circuit. In some embodiments, the circuit may connect a battery of the electronic lock 100 to one or more of a processor, a network interface, a motor, a memory, a sensor, a camera, or another component or set of components of the electronic lock 100. The components that are activated may depend on the embodiment of the electronic lock 100 and on the use case. As an example, if a user physically interacts with the electronic lock 100, then the processor 144 and keypad 120 may be activated so that the user may actuate the lock using the keypad. As another example, if the electronic lockset 100 detects that a user left the premises (e.g., based on location information, camera information, a mobile device connection status, etc.), then a network interface may be activated to enable communication with the user. As another example, the electronic lockset 100 may determine, based on a schedule, that a certain component or set of components is likely to be used during a certain time and may activate that component or set of components. Generally, the electronic lockset 100 may determine which components to activate or deactivate, based on a user interaction, a status of the electronic lockset 100 or other devices, available components of the electronic lockset 100, contextual information, and other data.

In some embodiments, once the lock circuitry is active, the motor 140 and keypad 120 may be used to actuate the lock. Once the circuit is active, a battery may provide power to one or more network interface units, such as one or more of the interfaces 147, 148, or 151 described above. In some instances, the lock circuit may already be active, in which case the physical input may not have an effect, as the lock circuitry may continue to be active. In the example of FIG. 10, activating electrical components may be caused by a physical connecting of lock circuitry. In other embodiments, however, activating components may be caused by a processor of the electronic lock 100 powering on, powering off, or changing a power state of components of the electronic lock 100 using software or a combination of software and hardware.

In some embodiments, activating or deactivating an electrical component may include using a mechanical or an electrical switch. In some embodiments, activating or deactivating an electrical component may include directly connecting or disconnecting a battery from the electrical component. Other techniques may also be implemented to activate and deactivate an electrical component, some of which may include fully disconnecting and reconnecting a battery from the electrical component, and some of which may include partially disconnecting the battery from the electrical component. In some instances, semiconductors (e.g., transistors, such as MOSFET transistors) can be used to activate and deactivate an electrical component.

In the example shown, the electronic lock 100 may receive a code (step 1006). For example, the electronic lock 100 may receive a code input by a user via the keypad 120. In some embodiments, the electronic lock 100 may receive a code via one or more network interfaces. For example, in some embodiments, the electronic lock 100 may receive a code from the mobile device 200 via the low-power network communication interface. A code received via the low-power network interface may be encrypted by a mobile device and decrypted by the electronic lock. In some embodiments, the code received by the electronic lock may be part of an initial communication received by the electronic lock 100. In some embodiments, the electronic lock 100 may receive code via a high-power network interface. In some embodiments, the electronic lock 100 may receive a code from the server 18.

In the example shown, the electronic lock 100 may determine whether a code is valid (step 1008). For example, the electronic lock 100 may compare the code input by the user to a code that is stored in a memory of the electronic lock 100. In some embodiments, the code stored in the memory of the electronic lock 100 may have been previously programmed by the user that entered the code via the keypad 120 or by another user, administrator, or manufacturer. In some embodiments, the electronic lock 100 may store a plurality of codes that are valid, and the electronic lock 100 may compare the code input via the keypad 120 to the plurality of stored codes to determine whether there is a match. In some embodiments, the one or more stored codes may be encrypted. In some embodiments, if the code input by the user matches a stored code, then the code input by the user is valid. In some embodiments, the electronic lock 100 may provide the code to another device (e.g., a server or security system) to determine whether the code is valid. In response to determining that the code is valid, the electronic lock 100 may actuate a motor (e.g., taking the “YES” branch to the step 1010). In response to determining that the code is not valid, the electronic lock may not actuate the motor (e.g., taking the “NO” branch to the step 1012).

In the example shown, the electronic lock 100 may actuate the motor (step 1010). For example, the motor 140 described above may be actuated, causing the bolt 114 to extend or retract, thereby locking or unlocking the door 14. In some embodiments, the motor may be an electric motor. In some embodiments, the processor 144 may actuate the motor 140 by sending it a lock signal, an unlock signal, or an actuate signal. In examples, the signal sent by the processor may depend on a current lock status of the door 14 (e.g., if the door is in a locked state, then the processor may provide an unlock signal to the motor).

In the example shown, the electronic lock may enter a time delay (step 1012). Depending on the embodiment and depending on an action of a user, the length of the time delay may vary. For example, in some instances, the user may enter another code, which may be received by the electronic lock 100 (e.g., returning to the step 1006). For example, a user may have first entered an invalid code, and the door may not have unlocked. In some embodiments, the user may attempt to enter another code. In some embodiments, the user may interact with a physical component of the electronic lock 100 to exit the time delay 1012. In some embodiments, a user may release a physically manipulatable component. For example, the user may slide a cover (or release the cover to allow the cover to return to a default position). As another example, the user may press a button, flip a switch, pull a lever, use a physical key or other physical component that may actuate the lock, release a component, or perform another action. In some embodiments, the user may communicate with the electronic lock 100 using the mobile device 200 and a network interface of the electronic lock 100 to exit the time delay 1012. In some embodiments, the electronic lock 100 may remain in the time delay until receiving a communication from a server (e.g., an instruction to power down or an instruction to perform another action).

In some embodiments, the user's interaction with the electronic lock 100 (e.g., via a physical component or the mobile device 200) may cause components of the electronic lock 100 to deactivate (e.g., causing the electronic lock 100 to proceed to the step 1014). In some embodiments, the time delay may last for an amount of time, and once that time is elapsed, the electronic lock 100 may deactivate components (e.g., proceeding to the step 1014). The amount of time for the time delay may vary by embodiment. For example, the amount of time for the time delay may be 10 seconds, 30 seconds, 1 minute, or a different amount of time. In some embodiments, the time delay may be implemented by a switch on a timer. In some embodiments, the electronic lock 100 may perform a different operation. For example, the electronic lock 100 may receive another physical input from the user (e.g., returning to the step 1002). For example, the user may press the button or a slide a cover, which may cause circuitry to be connected. In some embodiments, the electronic lock 100 may receive a communication from the server 18 or mobile device 200 via one or more network interfaces and, in response to the communication, exit the time delay (e.g., by proceeding to deactivate components or perform another operation).

In the example shown, the electronic lock 100 may deactivate components (step 1014). For example, the electronic lock 100 may deactivate one or more of a circuit, battery, network interface, motor, processor, or other component. In some embodiments, the electronic lock 100 may power down one or more components. In some embodiments, one or more components may be physically disconnected from a power source; in other embodiments, the one or more components may not be physically disconnected from a power source, but they may be powered down. As an example, the user may physically disconnect a circuit by interacting with a component of the electronic lock 100 (e.g., by pressing a button, flipping a switch, sliding a cover, allowing a cover to slide, etc.). As another example, a timed switch may flip, causing the circuitry to disconnect. In some embodiments, the electronic lock 100 may power down one or more components using software or a combination of software and hardware. Once components are deactivated, power of a battery of the electronic lock 100 may be saved, and battery life of the electronic lock 100 may be extended. In some embodiments, even though components of the electronic lock may not be active, the lock may nevertheless be actuated by other means, such as a key, turn piece, or other component.

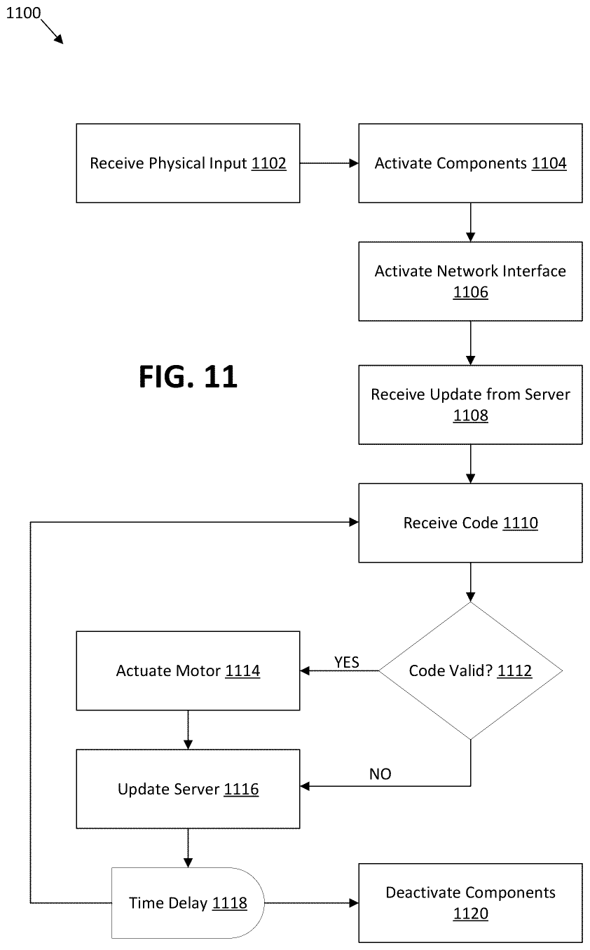

FIG. 11 is a flowchart of a method 1100 of operating an electronic lock, according to a further example. In the example of FIG. 11, the electronic lock 100 may include a network interface that may be activated in response to a physical user input. The electronic lock 100 may use the network interface to communicate with a server (e.g., receive updates from the server and provide updates to the server). The network interface and other components of the electronic lock 100 may power down once the user is finished using the lock. Advantageously, the electronic lock 100 may preserve energy by keeping the network interface and other electrical components of the electronic lock 100 deactivated until a physical input is received form a user. In addition to power savings, the electronic lock 100 may still communicate with a server to provide and receive updates.

In the example shown, the electronic lock 100 may receive a physical input (step 1102). An example of receiving a physical input is described above in connection with the step 1002 of FIG. 10.

In the example shown, the electronic lock 100 may activate components (step 1104). An example of activating lock circuitry is described above in connection with the step 1004 of FIG. 10.

In the example shown, the electronic lock 100 may activate a network interface (step 1106). For example, a network interface may receive power from the battery and, in some embodiments, may receive signals from a processor. Once the lock circuitry is activated, the battery may begin to provide power to the network interface. In some embodiments, the network interface may receive or provide signals to external devices, such as the mobile device 200 or the server 18. In some embodiments, the activated network interface may connect the electronic lock 100 to the internet. As a result, the electronic lock 100 may be connected to a cloud-based server. In some instances, the network interface may already be active, in which case the network interface need not be reactivated; however, in some instances, a timer associated with the network interface activation may reset. In some embodiments, the electronic lock 100 may activate a first network interface but not activate a second network interface. For example, the electronic lock 100 may activate a low-power network interface for communicating with a proximate mobile device or IoT device but may not activate a high-power network interface, as the high-power network interface may not be required, or power may be saved by not activating the high-power network interface. Conversely, in some instances, the electronic lock 100 may activate a high-power network interface but may not activate a low-power network interface.

In the example shown, the electronic lock 100 may receive an update from a server (step 1108). For example, the electronic lock 100 may receive an update from the server 18 via the activated network interface. In some embodiments, the update may be received via a high-power network interface, such as a Wi-Fi interface. In some embodiments, the update may be received via a low-power network interface. For example, a different device, such as a mobile phone or an IoT hub may receive an update over the internet from the server. The mobile phone or IoT hub may then provide the update to the electronic lock 100 using a different network protocol, such as BLE, Thread, or another protocol.

In some embodiments, the update may relate to an account update, a password update, a software update, an update related to an electronic lock application, a data update, or another update. As an example, a user may access the server 18 to update a code for the electronic lock 100 (e.g., via a web browser or mobile application). The server 18 may push the update to the electronic lock 100, but aspects of the electronic lock 100 may, in some instances, be powered off. However, once components of the electronic lock 100 are activated or powered on, the electronic lock 100 may receive the updated code from the server 18 and update data that is stored in memory of the electronic lock. Other updates may, in some instances, be pushed to the electronic lock in a similar manner. In addition to receiving updates from a server, the electronic lock 100 may also communicate with nearby devices, such as IoT devices or an IoT hub. In some embodiments, the electronic lock 100 may connect with new devices or receive updates from devices.

In the example shown, the electronic lock 100 may receive a code (step 1110). An example of receiving a code is described above in connection with the step 1006 of FIG. 10.

In the example shown, the electronic lock 100 may determine whether the code is valid (step 1112). An example of determining whether the code is valid is described above in connection with the step 1008 of FIG. 10. In response to determining that the code is valid, the electronic lock 100 may actuate a motor (e.g., taking the “YES” branch to the step 1114). In response to determining that the code is not valid the electronic lock 100 may skip actuating the motor (e.g., taking the “NO” branch to the step 1116).

In the example shown, the electronic lock 100 may actuate the motor (step 1114). An example of actuating the motor is described above in connection with the step 1010 of FIG. 10.

In the example shown, the electronic lock 100 may update a server (step 1116). For example, the electronic lock 100 may use the activated network interface to update the server 18. In some embodiments, the electronic lock 100 may update the server using the same network used to receive updates from the server. In some embodiments, the electronic lock 100 may route updates to a nearby device over a network (e.g., to a mobile device or router), and the nearby device may provide the updates to the server. In some embodiments, the electronic lock 100 may provide the updates directly to the server. In some embodiments, the electronic lock 100 may determine whether the electronic lock is coupled to a mobile phone or other device over BLE, Thread, or another low-power network. If so, the electronic lock 100 may send the updates to the server using BLE, Thread, or another low-power network via the mobile phone or other device. If not, the electronic lock 100 may send updates to the server 18 using Wi-Fi (or another high-power network). In a similar manner, the electronic lock 100 may, when possible, prioritize communicating (e.g., to the server 18 or to other devices, such as the mobile device 200) over networks that require less power than networks that require more power.

In some embodiments, the electronic lock 100 may, as part of providing updates, provide data indicating whether the code was valid (e.g., whether a user successfully actuated the lock). Furthermore, in some embodiments, the electronic lock 100 may provide data indicating a way the lock was actuated (e.g., using a code input via a keypad, using a physical key, using another physical component such as a turn piece, latch, or other component, or in another manner). Additionally, the electronic lock 100 may provide other data to the server 18, such as a time or date at which the lock was actuated, a status of the lock (e.g., whether locked or unlocked), a status of a battery (e.g., a percentage of battery life remaining), data related to a user that actuated the lock, camera footage (in some embodiments), or other data. In some embodiments, the server may store the updates and associate the updates with an account associated with the electronic lock 100 or a user. The updates may, in some embodiments, be viewed by a user that accesses the server 18. In some embodiments, the server 18 may notify a user of an update by pushing a notification to a mobile application on the user's mobile device, texting the user, calling the user, or performing another operation.

In the example shown, the electronic lock 100 may enter a time delay (step 1118). An example of a time delay, including operations that may follow from the time delay, are described above in connection with the step 1012 of FIG. 10.

In the example shown, the electronic lock 100 may deactivate components (step 1120). An example of deactivating components is described above in connection with the step 1014 of FIG. 10. As a result of deactivating components (e.g., a network interface, processor, keypad, motor, etc.), the electronic lock 100 may preserve battery power and extend battery life.

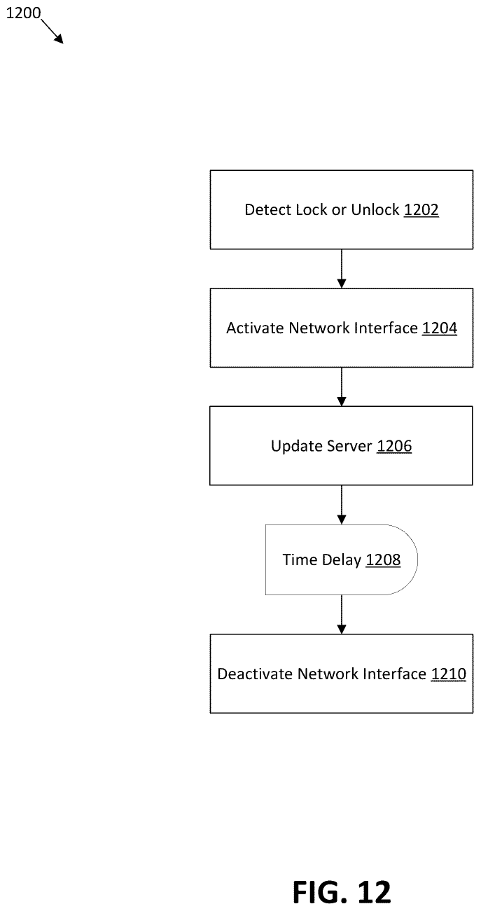

FIG. 12 is a flowchart of an example method 1200 of operation of an electronic lock. In the example of FIG. 12, the electronic lock 100 may detect an actuation of the lock, either from a locked state to an unlocked state or from an unlocked state to a locked state (e.g., via a key, turn piece, latch, button, etc.). In response to detecting the lock actuation, the electronic lock 100 may activate a network interface, which may update a server regarding a status of the lock, a time, a date, or other information. Advantageously, aspects of the method 1200 preserve battery power by only activating a network interface when the lock is actuated, while also allowing a user to track lock and unlock events using services associated with the server 18 (e.g., using a mobile application or website).

In the example shown, the electronic lock 100 may detect a lock actuation (step 1202). The lock actuation may be triggered either from the interior or exterior side of the lock. The lock actuation may be triggered by one of a plurality of manners of actuating the lock including, but not limited to, using a key; a turn piece; a latch; sliding, fixing, or releasing a bolt; pressing a button to electronically actuate the lock; or another manner. The lock actuation may either lock or unlock the electronic lock 100. In some embodiments, the electronic lock 100 may detect the lock actuation using a sensor. The sensor may detect one or more of movement or pressure.

In the example shown, the electronic lock 100 may activate a network interface (step 1204). For example, in response to detecting the actuation of the lock, the electronic lock 100 may turn on or provide power to the network interface. In examples, this may include closing a circuit so that the network interface receives power from a battery. An example of activating a network interface is described above in connection with the step 1204 of FIG. 12. In some embodiments, the electronic lock 100 may also activate other components.

In the example shown, the electronic lock 100 may update a server (step 1206). An example of updating a server is described above in connection with the step 1116 of FIG. 11.

In the example shown, the electronic lock 100 may enter a time delay (step 1208). An example of a time delay, including operations that may follow from the time delay, is described above in connection with the step 1012 of FIG. 10. Though not illustrated, in some embodiments, the electronic lock 100 may detect actuation of the lock, thereby returning to the step 1202. As an example, a user may unlock a door from an exterior, enter a premises, and lock the door from an interior. Both lock actuations may be sent as updates to the server, and the network interface may not, in some instances, be deactivated and reactivated between the lock actuations.

In the example shown, the electronic lock 100 may deactivate the network interface (step 1210). For example, the electronic lock power down the network interface or may disconnect circuitry that coupled the network interface with a power source. An example of deactivating components, including the network interface, is described above in connection with the step 1012 of FIG. 10.

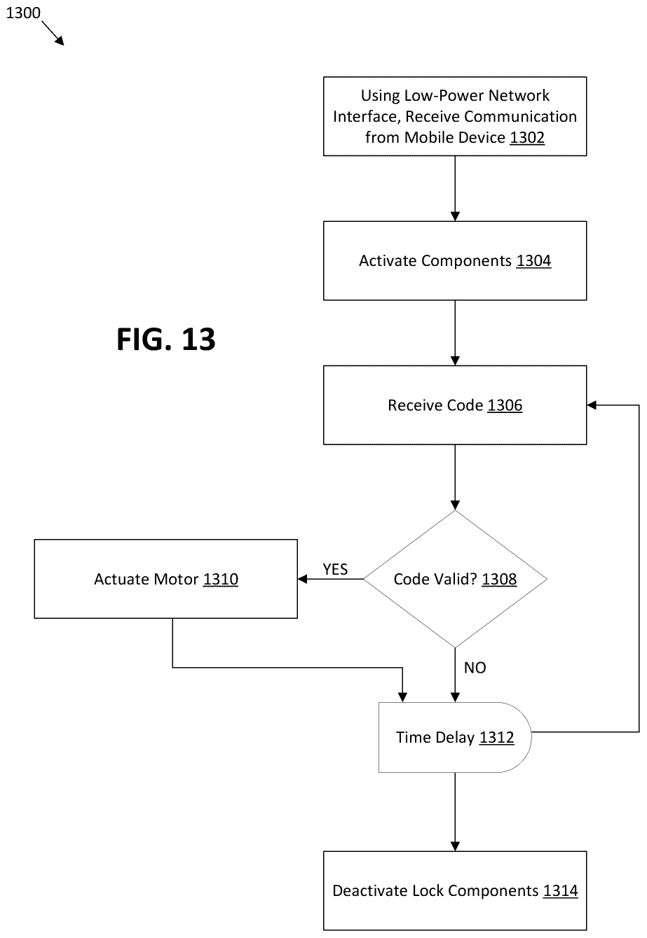

FIG. 13 is a flowchart of an example method 1300, illustrating operation of an electronic lock. In the example of FIG. 13, the electronic lock 100 may include a low-power network interface. The electronic lock 100 may receive a communication via the low-power network interface. In response, the electronic lock 100 may activate circuitry so that the lock may be actuated. The user may provide a code via the low-power network interface or via another means, such as a keypad. The electronic lock 100 may validate the code and actuate the lock in response to determining that the code is valid. Advantageously, aspects of the method 1300 may preserve lock battery by implementing a low-power network interface and by keeping lock components inactive until a communication is received over the network interface, while also allowing a user to utilize a mobile device to interact with and actuate the lock.

In the example shown, the electronic lock 100 may, using a low-power network interface, receive a communication from a mobile device (step 1302). In some embodiments, the low-power network interface may be a Bluetooth interface, an NFC interface, a Thread interface, a low-power Wi-Fi interface (e.g., an interface configured to implement a subset of the Institute of Electrical and Electronics Engineers (IEEE) 802.11 standard for Wi-Fi communication, such as the subset described by IEEE 802.11ba), a low-power wide-area network interface, or another wireless network interface. The mobile device (e.g., the mobile device 200) may connect with the electronic lock 100 by sending or receiving a communication over a network associated with the low-power network interface. In some embodiments, the mobile device 200 may provide credentials or user information. In some embodiments, the mobile device 200 may provide a request, such as a request to actuate a lock or to activate lock components. In some embodiments, the electronic lock 100 may provide information to the mobile device 200 using the low-power network interface, such as an amount of battery life remaining or other data. In some embodiments, the electronic lock 100 may receive a communication from a device other than the mobile device 200, such as a server, IoT hub, or IoT device.

In the example shown, the electronic lock 100 may activate lock components (step 1304). For example, the electronic lock 100 may activate lock components (e.g., a circuit and components coupled to the circuit) in response to receiving the communication from the mobile device via the low-power network interface. An example of activating lock components is described above in connection with the step 1004 of FIG. 10. In some embodiments, the electronic lock 100 may only activate lock components after receiving a code from the mobile device and validating the code.

In the example shown, the electronic lock 100 may receive a code (step 1306). An example of receiving a code is described above in connection with the step 1006 of FIG. 10.

In the example shown, the electronic lock 100 may determine whether the code is valid (step 1308). An example of determining whether a code is valid is described above in connection with the step 1008 of FIG. 10. In response to determining that the code is valid, the electronic lock 100 may actuate a motor (e.g., takin the “YES” branch to the step 1310). In response to determining that the code is not valid, the electronic lock 100 may not actuate the motor (e.g., taking the “NO” branch to the step 1312).

In the example shown, the electronic lock 100 may actuate the motor (step 1310). An example of actuating the motor is described above in connection with the step 1010 of FIG. 10.

In the example shown, the electronic lock 100 may enter a time delay (step 1312). An example of a time delay, including operations that may follow from the time delay, are described above in connection with the step 1012 of FIG. 10.

In the example shown, the electronic lock 100 may deactivate lock components (step 1314). An example of deactivating lock components is described above in connection with the step 1014 of FIG. 10. In some embodiments, the electronic lock 100 may keep active the low-power network interface. For instance, the electronic lock may include multiple circuits, one of which provides power to the low-power network interface and another of which provides power to other components, such as a motor or a high-power network interface. In examples, the electronic lock 100 may only disable the circuitry that provides power to the other components while keeping the low-power network interface active.

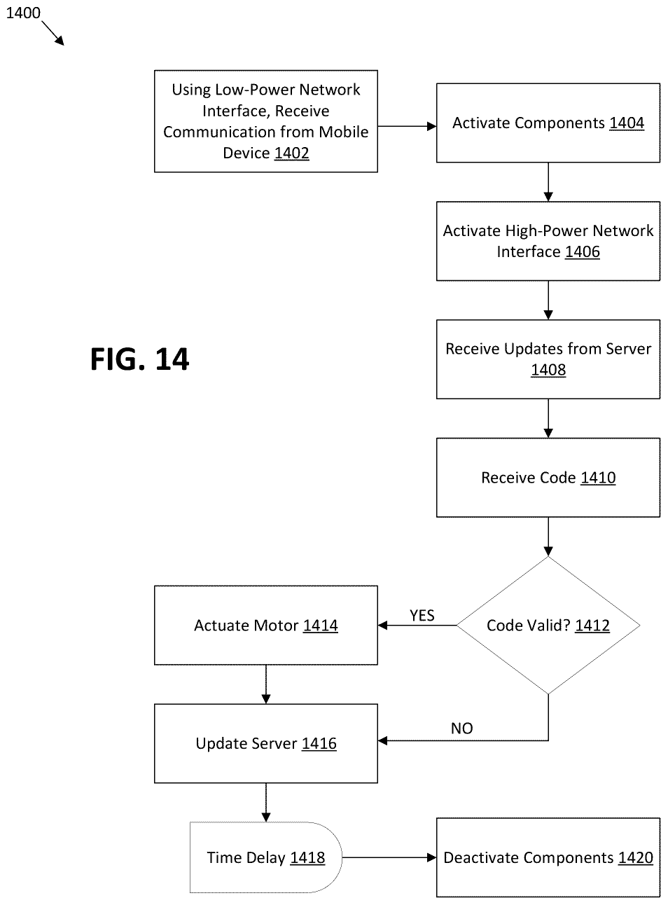

FIG. 14 is a flowchart of a method 1400. In the example of FIG. 14, the electronic lock 100 may include a low-power network interface that remains active and is configured to communicate with a nearby device. In response to detecting a nearby device (e.g., by receiving a communication from the mobile device 200 or from another device, such as an IoT hub or device), the electronic lock 100 may activate components to actuate a lock. Additionally, the electronic lock 100 may communicate with a remote server. To do so, the electronic lock 100 may, in some embodiments, activate a high-power network interface that may connect to the internet. In some embodiments, the electronic lock 100 may communicate with the server via the mobile device or via another device. Advantageously, aspects of the method 1400 may allow the electronic lock 100 to communicate with the server 18, allow a user to activate or interact with the electronic lock 100 using a mobile device via the low-power network interface, and allow the electronic lock 100 to save battery power by keeping electrical components deactivated until the low-power network interface receives a communication.

In the example shown, the electronic lock 100 may, using a low-powered network interface, receive a communication from a mobile device (step 1402). An example of receiving a communication via a low-power network interface is described above in connection with the step 1302 of FIG. 13.

In the example shown, the electronic lock 100 may, in response to receiving the communication via the low-power network interface, activate components (step 1404). An example of activating components is described above in connection with the step 1004 of FIG. 10.

In the example shown, the electronic lock 100 may activate a high-power network interface (step 1406). In some embodiments, the high-power network interface may consume more power than the low-power network interface, and in some embodiments, the high-power network interface may be configured to have a higher throughput than the low-power network interface. In some embodiments, the high-power network interface may include a Wi-Fi interface, a cellular communication interface, or another type of network interface. The high-power network interface may enable communication between the electronic lock 100 and the server 18. For example, the Wi-Fi interface may enable the electronic lock 100 to communicate with a router that connections the electronic lock 100. In some embodiments, activating the lock components may include activating the high-power network interface.

In the example shown, the electronic lock 100 may receive updates from a server (step 1408). An example of receiving updates from the server, and of updating aspects of the electronic lock 100 in response to the updates, is described in connection with the step 1108 of FIG. 11. In some embodiments, the electronic lock 100 may receive updates via the high-power network interface 1486 (e.g., over a Wi-Fi network or cellular network). In some embodiments, the server may send updates to the mobile device, and the electronic lock 100 may receive the updates from the mobile device via the low-power network interface.

In the example shown, the electronic lock 100 may receive a code (step 1410). For example, the electronic lock 100 may receive a code from the user's mobile device via the low-power or high-power network interface, or the electronic lock 100 may receive a code input via the keypad 120. An example of receiving a code is described above in connection with the step 1006 of FIG. 10.

In the example shown, the electronic lock 100 may determine whether the code is valid (step 1412). An example of determining whether a code is valid is described above in connection with the step 1008 of FIG. 10. In response to determining that the code is valid, the electronic lock 100 may actuate a motor (e.g., taking the “YES” branch to the step 1414). In response to determining that the code is not valid, the electronic lock 100 may not actuate the motor (e.g., taking the “NO” branch to the step 1416).

In the example shown, the electronic lock 100 may actuate the motor (step 1414). An example of actuating the motor is described above in connection with the step 1010 of FIG. 10.

In the example shown, the electronic lock 100 may update the server (step 1416). An example of updating the server is described above in connection with the step 1116 of FIG. 11.

In the example shown, the electronic lock 100 may enter a time delay (step 1418). An example of a time delay, including operations that may follow from the time delay, are described above in connection with the step 1012 of FIG. 10.

In the example shown, the electronic lock 100 may deactivate components (step 1420). For example, the electronic lock 100 may deactivate lock circuitry and the high-power network interface. An example of deactivating components is described above in connection with the step 1014 of FIG. 10. In some embodiments, as described above in connection with the step 1314 of FIG. 13, the electronic lock 100 may keep active the low-power network interface.

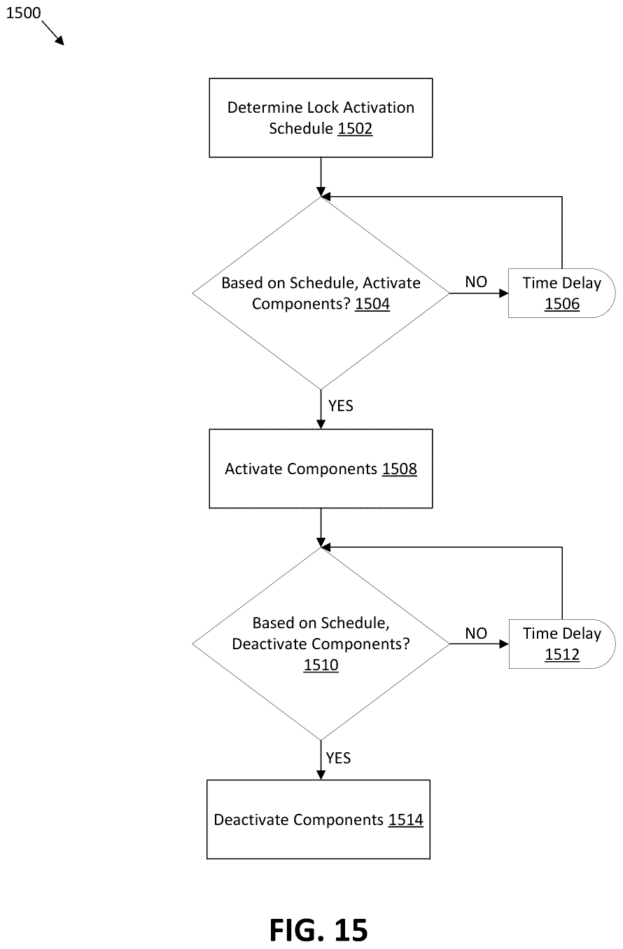

FIG. 15 is a flowchart of an example method 1500. In the example of FIG. 15, the electronic lock 100 may determine whether to activate lock components based on a schedule. Activating the lock components may include activating one or more of a network interface or a mechanism for actuating the lock. In some embodiments, the schedule may be programmed by a user. In some embodiments, the schedule may be learned by the electronic lock 100 or the server 18 based on historical usage patterns of a user or historical location patterns of a user. Advantageously, aspects of the method 1500 may conserve battery power by deactivating lock circuitry when electrical lock components are less likely to be used based on a user-created schedule or based on a learned schedule. Furthermore, aspects of the method 1500 allow a user to customize when electrical components of a lock are active.

In the example shown, the electronic lock 100 may determine a lock activation schedule (step 1502). The lock activation schedule may, in some embodiments, include a schedule for a plurality of components of the electronic lock. For example, there may be a schedule for one or more of a first network interface, a second network interface, a keypad, or another component. The lock activation schedule may include times, days, and dates. For instance, a schedule may indicate that one or more components are to be deactivated from 10PM to 6AM for each day of the week. As another example, the lock activation schedule may indicate that the one or more components are to be disabled from November to April, except for a few days in December. In some embodiments, the activation schedule is programmed by a user. For instance, the user may directly program an activation schedule into the electronic lock 100 by using components of the electronic lock 100 or by using a mobile device that is coupled to the electronic lock 100. As another example, the user may provide a schedule to the server 18, which may provide the activation schedule to the electronic lock 100. In some embodiments, the electronic lock 100 may infer an activation schedule based on usage patterns of a user. For example, the electronic lock may determine that a user has never used a lock from between 12AM to 4AM, or that the user has never used the lock on a weekday. Based on these patterns, the electronic lock 100 may, in some embodiments, determine an activation schedule to conserve battery power when a user is unlikely to use the lock.

In the example shown, the electronic lock 100 may determine, based on an activation schedule, whether to activate components (step 1504). For instance, the electronic lock 100 may compare a current time (e.g., determined by using an internal timer or other means) to an activation schedule. If components are scheduled to be activated, the electronic lock 100 may activate them (e.g., taking the “YES” branch). If not, the electronic lock 100 may proceed to the time delay 1506 (e.g., takin the “NO” branch). At the time delay 1506, the electronic lock 100 may wait for a predetermined amount of time (e.g., 30 seconds, 1 minute, 5 minutes) before checking again whether components are to be activated (thereby returning to the step 1504). In some embodiments, the electronic lock 100 may exit the time delay 1506 in response to detecting a change to an activation schedule (thereby returning to the step 1502 or 1504).

In the example shown, the electronic lock 100 may activate components (step 1508). An example of activating components is described above in connection with the step 1004 of FIG. 10. Additionally, in some embodiments, the electronic lock 100 may activate only those lock components that are scheduled to be active. For instance, at a first time, a low-power network interface may be activated so that a user may interact with the lock using a mobile device, but a high-power network interface may not be scheduled to be activated at the first time. As a result, the electronic lock may only activate the low-power network interface and wait, for example, until a second time to activate the high-power network interface. In a similar manner, the electronic lock 100 may selectively activate components based on activation schedules.

In the example shown, the electronic lock 100 may determine, based on a schedule, whether to deactivate components (step 1510). For example, the electronic lock 100 may determine a current time and determine, based on an activation schedule, whether a currently active component is schedule to be deactivated. If so, the electrical lockset 100 may deactivate the component (e.g., taking the “YES” branch to the step 1514). If not, the electrical lockset 100 may enter the time delay 1512. At the time delay 1512, the electronic lock 100 may wait for a predetermined amount of time (e.g., 30 seconds, 1 minute, 5 minutes) before checking again whether components are to be deactivated (thereby returning to the step 1510). In some embodiments, the electronic lock 100 may exit the time delay 1512 in response to detecting a change to an activation schedule (thereby returning to the step 1502 or 1510).

In the example shown, the electronic lock 100 may deactivate components that are scheduled to be deactivated (step 1514). An example of deactivating components is described above in connection with the step 1014 of FIG. 10.

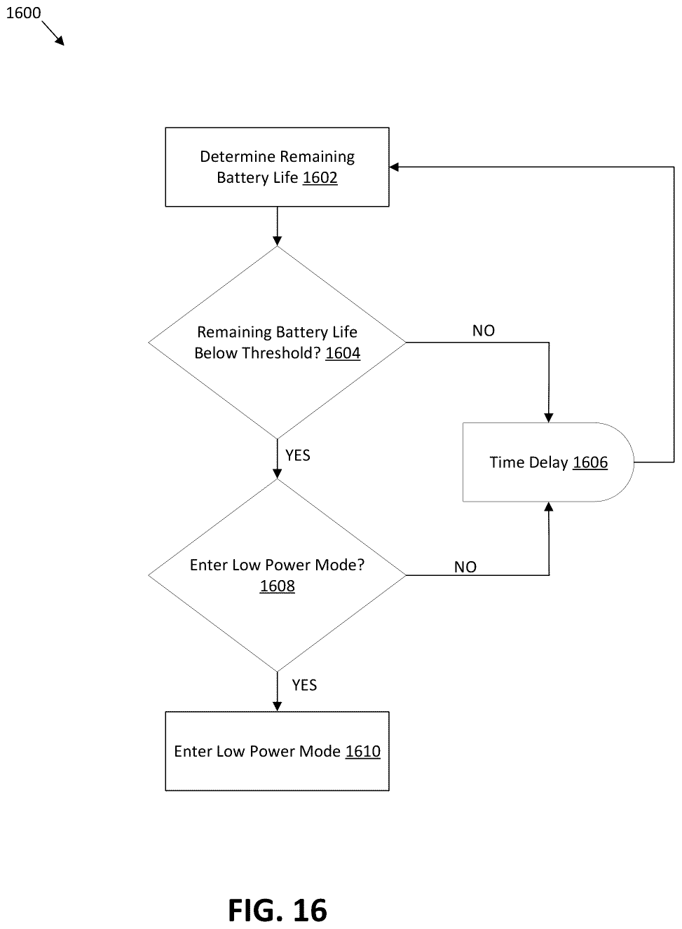

FIG. 16 is a flowchart of an example method 1600. In the example of FIG. 16, the electronic lock 100 may determine whether to enter a low power mode based on a remaining battery power of the lockset and based on other conditions. In a low power mode, one or more electrical components of the electronic lock 100 may be disabled. Furthermore, in some embodiments, when the lockset is in a low power mode, the lockset may be on standby and may be configured to receive only an input that causes the lockset to activate additional electrical components or functions. Such an input could be, for example, a movement of a physically manipulatable component, such as a press of a button or a slide of a cover.

Advantageously, aspects of the method 1600 may allow the electronic lock 100 to include and use electrical components, such as components for interacting with a server or external device. Additionally, the electronic lock 100 may also have an extended battery life, given that the electronic lock 100 may automatically detect when a battery life is low and, in some instances, enter a low power mode to extend the battery life of the electronic lock 100.

In the example shown, the electronic lock 100 may determine a remaining battery life (step 1602). In some embodiments, the electronic lock 100 may track how much energy the battery has expended, and based on this amount, determine how much battery life is remaining. In some embodiments, the electronic lock 100 may check a voltage of the battery to determine how much battery life is remaining. In some embodiments, other techniques may be used to determine a battery life. In some embodiments, the electronic lock 100 may determine a remaining life for a plurality of batteries. In some embodiments, the remaining battery life may be a percentage of a battery when fully charged. In some embodiments, the remaining battery life may be an amount of time that the battery will last at a current or expected use of the electronic lock 100.

In the example shown, the electronic lock 100 may determine whether the remaining battery life is below a threshold (step 1604). For example, a user or manufacturer of the electronic lock 100 may set a threshold, and if the remaining battery life is below that threshold, the electronic lock 100 may enter a low power mode. Example thresholds may be 10%, 25%, 50%, or another percentage of a total energy for one or more batteries. In some embodiments, the electronic lock 100 may determine whether an expected duration in time of the battery is below a threshold. For instance, the electronic lock 100 may determine whether an expected life of a battery at a current or expected use is longer than an hour, a day, a week, or another length of time. In response to determining that the battery life is below the threshold, the electronic lock 100 may determine whether to enter a low power mode (e.g., taking the “YES” branch to the step 1608). In response to determining that the remaining battery life is not below the threshold, the electronic lock 100 may proceed to the time delay 1606 before determining the battery life again (e.g., takin the “NO” branch to the step 1606).

In the example shown, the electronic lock 100 may determine whether to enter a low power mode (step 1608). In some embodiments, the electronic lock 100 may ask a user whether to enter the low power mode (e.g., by sending a message to the mobile device 200 cither directly or via the server 18). In some embodiments, the electronic lock 100 may not ask the user whether to enter the low power mode. In some embodiments, the electronic lock 100 may be configured to permit or not permit a low power mode during certain times or under certain conditions. For instance, the electronic lock 100 may, in some embodiments, not go into a low power mode during a period of frequent use (e.g., a recent use or time during which a user frequently uses the electronic lock 100) or if the electronic lock 100 is communicating with the server 18. In response to determining to enter the low power mode, the electronic lock 100 may enter the low power mode (e.g., taking the “YES” branch to the step 1610). In response to determining not to enter the low power mode, the electronic lock 100 may enter the time delay 1606 and repeat aspects of the method 1600 (e.g., taking the “NO” branch to the step 1606).

In the example shown, the electronic lock 100 may enter the low power mode (step 1610). In the low power mode, the electronic lock 100 may deactivate one or more electrical components or functions. An example of deactivating components is described above in connection with the step 1014 of FIG. 10. In some instances, a low power mode may result in some electrical components being deactivated while others remain active. As an example, a network interface (e.g., for communicating with the server 18) may be deactivated while circuitry for actuating an electrical motor or a keypad may remain active. In some embodiments, a user or manufacturer of the electronic lock 100 may customize which components are deactivated during a low power mode and which components remain active. In some embodiments, there may be varying degrees of low power modes. For instance, as the battery power lowers, progressively more electrical components may be deactivated to extend the battery life. In some embodiments, the electronic lock 100 may automatically detect that a battery is being charged or that a battery charge becomes higher than a threshold and, in response, the electronic lock 100 may exit the low power mode, thereby activating one or more electrical components in some instances.

In some embodiments, the electronic lock 100 may enter a low power mode even if the battery life is not below a threshold. For example, the electronic lock 100 may have a setting for entering a low power mode, irrespective of whether the battery power is below a threshold. In such embodiments, the step 1604 may not be performed.

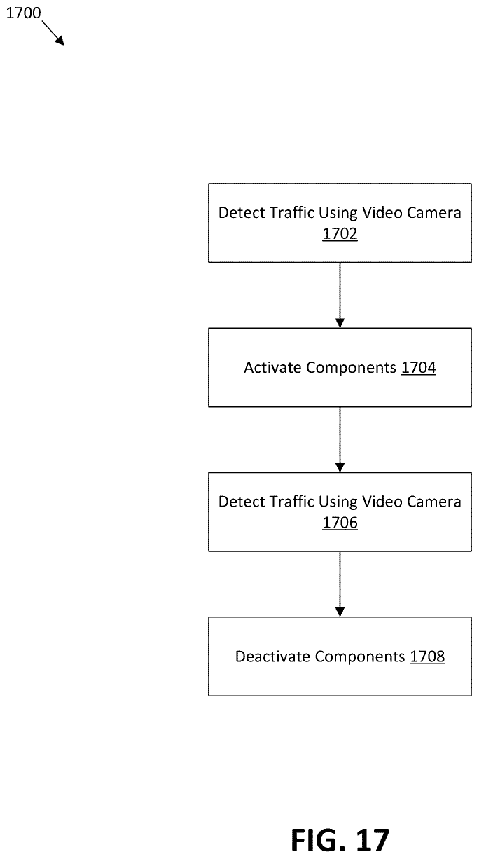

FIG. 17 is a flowchart of an example method 1700. In the example of FIG. 17, the electronic lock 100 may include or be coupled with cameras or sensors that track traffic of people into and out of a premises. For instance, via the camera, the electronic lock 100 may detect that user has left the premises at which the electronic lock 100 is located, and in response, the electronic lock 100 may activate components, such as a network interface to communicate with the server 18. As another example, the electronic lock 100 may determine, using the cameras, that all users are within the premises and, in response, deactivate certain features. Although the method 1700 is described in the context of using video cameras, in some embodiments, sensors other than video cameras may be used. Advantageously, aspects of the method 1700 may save battery power of the electronic lock by disabling features when they are not needed. Additionally, in some embodiments, a camera may use a different power source than a battery of the electronic lock 100. As a result, the battery power of the electronic lock 100 may not be reduced to monitor when electrical components of the electronic lock 100 are to be active.

In the example shown, the electronic lock 100 may detect traffic using a video camera (step 1702). For example, the camera may detect that a user left a premises. For embodiments in which the camera is separate (e.g., detached) from the electronic lock 100, the camera may send a signal or information to the electronic lock 100 indicating that a user left the premises. In examples, the camera may include or be coupled with a system for analyzing video data.

In the example shown, the electronic lock 100 may activate components (step 1704). An example of activating components is described above in connection with the step 1004 of FIG. 10. For example, having used the camera to detect that a user left the premises, the electronic lock 100 may activate components (e.g., a network interface) for remote communication with the user via the server 18. In some embodiments, however, the electronic lock 100 may not activate components after detecting that a user has left. For example, the electronic lock 100 may determine that there is still a user on the premises and therefore, in some embodiments, may not activate certain components.

In the example shown, the electronic lock 100 may detect traffic using the video camera (step 1706). For example, the camera may detect that a user has entered a premises. An example of using a camera to detect traffic is described above in connection with the step 1702.

In the example shown, the electronic lock 100 may deactivate components (step 1708). An example of deactivating components is described above in connection with the step 1014 of FIG. 10. For example, upon detecting using a camera that a user has returned to the premises, the electronic lock 100 may deactivate a component used to communicate remotely with the user (e.g., a network interface), because a remote connection with the user may not be necessary, as the user is on the premises. As a result, the electronic lock 100 may mitigate battery usage expended in operating a network interface or other component.

In some embodiments, the electronic lock 100 or another device or system (e.g., the mobile device 200 or the server 18) may activate and deactivate the video camera. For example, if the electronic lock 100 receives a communication from a nearby mobile device, then the electronic lock 100 may provide an activation signal to the camera. Relatedly, if a user physically interacts with the electronic lock 100 (e.g., presses a keypad, turns a handle, presses a button, inserts a key, etc.), then the electronic lock 100 may activate the camera. As another example, a user or administrator of the electronic lock 100 may, even if the user is remote from the electronic lock, provide an activation or deactivation command to the camera via the server 18. In some embodiments, the camera may be activated or deactivated based on a pre-programmed or learned activation schedule.

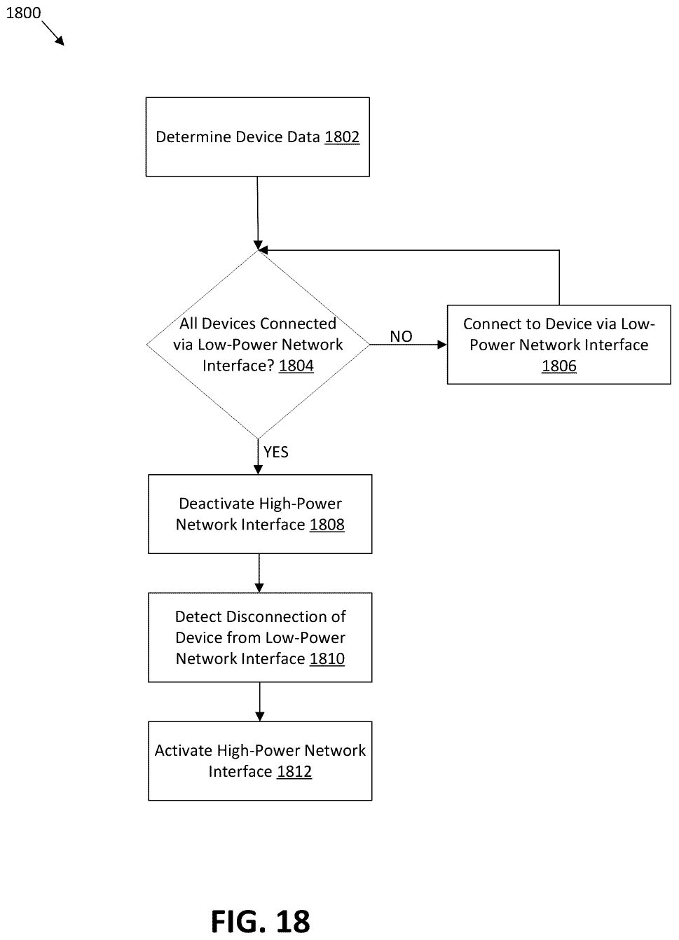

FIG. 18 is a flowchart of an example method 1800. In the example of FIG. 18, the electronic lock 100 may determine which devices it is paired with over a low-power network (e.g., BLE or Thread) and whether all devices registered with the electronic lock 100 are paired with the electronic lock 100 over that network. If so, the electronic lock 100 may deactivate a higher-powered network, such as Wi-Fi. The electronic lock 100 may activate the higher-powered network in response to detecting that a registered device has disconnected form the low-power network. Advantageously, aspects of the method 1800 allow the electronic lock 100 to save battery power by deactivating an interface for a network that requires more energy to communicate over when that interface is not required. For example, the method 1800 may provide one of many ways to prioritize a network that requires less energy when it is possible to do so.

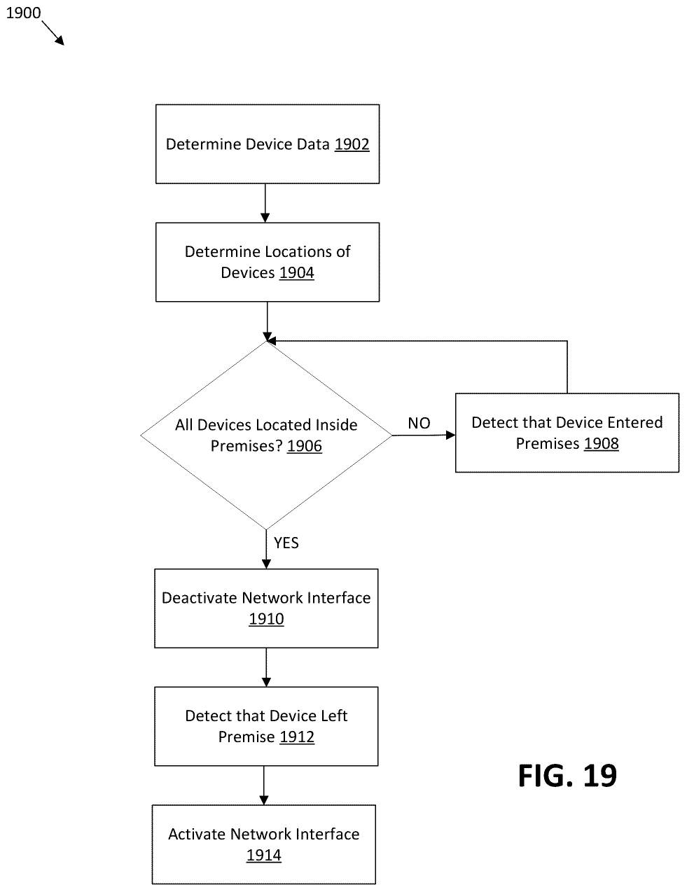

In the example shown, the electronic lock may determine device data (step 1802). For example, the electronic lock 100 may determine the number of devices registered with the electronic lock 100, and the electronic lock 100 may determine an identifier and device type of the devices registered with the electronic lock 100. In some embodiments, the electronic lock 100 may determine the number of devices paired with the electronic lock 100, and the electronic lock 100 may determine an identifier and a device type for paired device. Additionally, the electronic lock 100 may determine a network that is facilitating each of the pairings. For example, a device may be paired with the electronic lock 100 over one or more of a plurality of networks (e.g., BLE, Wi-Fi, Thread, etc.) over which the electronic lock 100 may be configured to communicate. In some instances, the devices may include mobile devices, such as the mobile device 200. In some embodiments, the relevant devices for the examples of FIGS. 18-19 may be devices that are configured to actuate the lock (e.g., mobile phones having access to a lock application) and may not include some other devices, such as IoT devices or gateways.

In the example shown, the electronic lock 100 may determine whether all devices are connected via the low-power network interface (step 1804). In some embodiments, the electronic lock 100 may determine, for each device that is registered with the electronic lock, whether the device is connected to the electronic lock 100 via the low-power network interface. In some embodiments, the electronic lock 100 may determine, for each device that is currently paired with the electronic lock, whether the device is connected to the electronic lock 100 via the low-power network interface. In response to determining that all devices are connected to the electronic lock 100 via the low-power network interface, the electronic lock 100 may deactivate a component (e.g., taking the “YES” branch to the step 1808). In response to determining that not all devices are connected to electronic lock 100 via the low-power network interface, the electronic lock 100 may, after a time delay, connect to a device via the low-power network interface (e.g., taking the “NO” branch to the step 1806).

In the example shown, the electronic lock 100 may connect to a device via the low-power network interface (step 1806). For example, a device may approach the electronic lock 100 and connect to the electronic lock 100 via the low-power network interface. As another example, a device may switch from communicating with electronic lock 100 via a high-power network interface to communicating with the electronic lock 100 via the low-power network interface. In examples, the electronic lock 100 may then determine whether all devices are connected via the low-power network interface (e.g., returning to the step 1804).

In the example shown, the electronic lock 100 may deactivate a high-power network interface (step 1808). For example, having determined that all devices are connected to the electronic lock 100 via the low-power network interface, the electronic lock 100 may deactivate the high-power network interface, thereby saving battery life. An example of deactivating components, which may include the high-power network interface, is described above in connection with the step 1014 of FIG. 10.

In the example shown, the electronic lock 100 may detect a disconnection of a device from the low-power network interface (step 1810). As examples, a device may leave the range of the low-power network, the device may switch to different network, or the device may power off or disconnect from the electronic lock 100.

In the example shown, the electronic lock 100 may activate a high-power network interface (step 1812). For example, in response to detecting that a formerly paired device or registered device is not connected via the low-power network interface, the electronic lock 100 may activate the high-power network interface. As a result, if the device left the range of the low-power network or otherwise may not be able to communicate via the low-power network, then the device may nevertheless interact with and control the electronic lock 100 by using the high-power networking interface.

FIG. 19 is a flowchart of an example method 1900. In the example of FIG. 19, the electronic lock 100 may triangulate locations of paired devices. If all devices are inside of a premises, then the electronic lock 100 may deactivate a network interface for connecting to the remote server 18. In response to detecting that a mobile device is no longer in the premises, then the electronic lock 100 may activate the network interface. Advantageously, aspects of the method 1900 allow the electronic lock 100 to conserve battery power by deactivating a network interface when a connection to a remote server may not be necessary; yet still, the electronic lock 100 may use low power connections with, or queries to, external devices to determine whether all devices are in a premises.

In the example shown, the electronic lock 100 may determine device data (step 1902). An example of determining device data is described above in connection with the step 1802 of FIG. 18.

In the example shown, the electronic lock 100 may determine locations of devices (step 1904). In some embodiments, the electronic lock 100 may determine locations of the devices that are registered with or paired with (e.g., over the internet or a different network) the electronic lock 100. To do so, the electronic lock 100 may, in some embodiments, send or receive a communication with each of the devices. In some embodiments, the electronic lock 100 may determine a location of one or more of the devices in a different manner. For example, the electronic lock 100 may query a device that knows the location of a device, such as a remote server, an IoT device that tracks location, or a device configured to read GPS data. In some embodiments, the electronic lock 100 may determine locations of devices that may not be paired with the electronic lock 100, such as registered devices that are not paired or potential guest devices. To do so, the electronic lock 100 may query the devices or query a different device or system that knows a location of one or more of the devices. In some embodiments, the electronic lock 100 may, to determine a location of a device, triangulate the device using one or more other devices, such as a router.

In the example shown, the electronic lock 100 may determine whether all devices are located inside premises at which the electronic lock 100 is located (step 1906). The premises may be, for example, a building, a parcel of one or more properties, or a geographically defined area. In some embodiments, the electronic lock 100 may determine whether each paired device is within the premises. In some embodiments, the electronic lock 100 may determine whether each registered device is located within the premises. In response to determining that all devices are located within the premises (e.g., taking the “YES” branch), the electronic lock 100 may deactivate a network interface (step 1910). In response to determining that not all devices are located within the premises (e.g., taking the “NO” branch), the electronic lock 100 may proceed to the step 1908.

In some embodiments, the premises may be defined by a geofence, and the electronic lock 100 may determine whether all devices are within an area defined by the geofence. For example, a user associated with the electronic lock 100 may establish a geofence. In some embodiments, a user may establish the geofence as a shape (e.g., a circle or polygon) that encompasses the electronic lock 100. In some embodiments, the user may configure the geofence so that the electronic lock 100, or another device, may receive an alert when a user enters or exits the geofence. In some embodiments, the geofence may use GPS systems, cellular towers, or other means for establishing and monitoring the geofence. In some embodiments, the electronic lock 100, or a device coupled to the electronic lock 100, may be actively listening for devices that enter or exit the geofence.

In the example shown, the electronic lock 100 may detect that a device entered the premises (step 1908). For instance, the electronic lock 100 may determine that a paired or registered device has entered the premises. In some embodiments, the device may alert the electronic lock 100—or the device may alert a different device, such as a hub or router, which may then alert the electronic lock—that the device has entered the premises. In some embodiments, the device may connect with the electronic lock 100 over a network, and the device may provide its location to the electronic lock 100, or the electronic lock 100 may infer the device's location based on the connection (e.g., given a network range, the electronic lock 100 may infer that the device is within a certain distance of the electronic lock 100). In some embodiments, by entering a geofence, the device may alert the electronic lock 100 that the device has entered the premises. In some embodiments, the electronic lock 100 may periodically determine device locations and thereby detect that the device has entered the premises. Having detected that a device entered the premises, the electronic lock 100 may redetermine whether all devices are inside the premises (step 1906). In some embodiments, the electronic lock 100 may return to the step 1902 or 1904.

In the example shown, the electronic lock 100 may deactivate a network interface (step 1910). An example of deactivating a network interface is described above in connection with the step 1210 of FIG. 12. Additionally, in some embodiments, deactivating the network interface may include stopping monitoring of the geofence.

In the example shown, the electronic lock 100 may detect that a device left the premises (step 1912). In some embodiments, the device leaving the premises, or another device that is coupled to the device leaving the premises, may alert the electronic lock 100 that the device left the premises. In some embodiments, the electronic lock 100 may periodically determine device locations (e.g., as described in connection with the step 1904) and thereby determine that a device left the premises. In some embodiments, by leaving the geofence, the device may alert the electronic lock 100 that the device left the premises.

In the example shown, the electronic lock 100 may activate a network interface (step 1914). An example of activating components, which may include the network interface, is described above in connection with the step 1004 of FIG. 10. Additionally, in some embodiments, activating the network interface may include monitoring the geofence. Having activated the network interface, the electronic lock 100 may repeat aspects of the method 1900 (e.g., going to the step 1908 in response to determining that a device entered a premises).

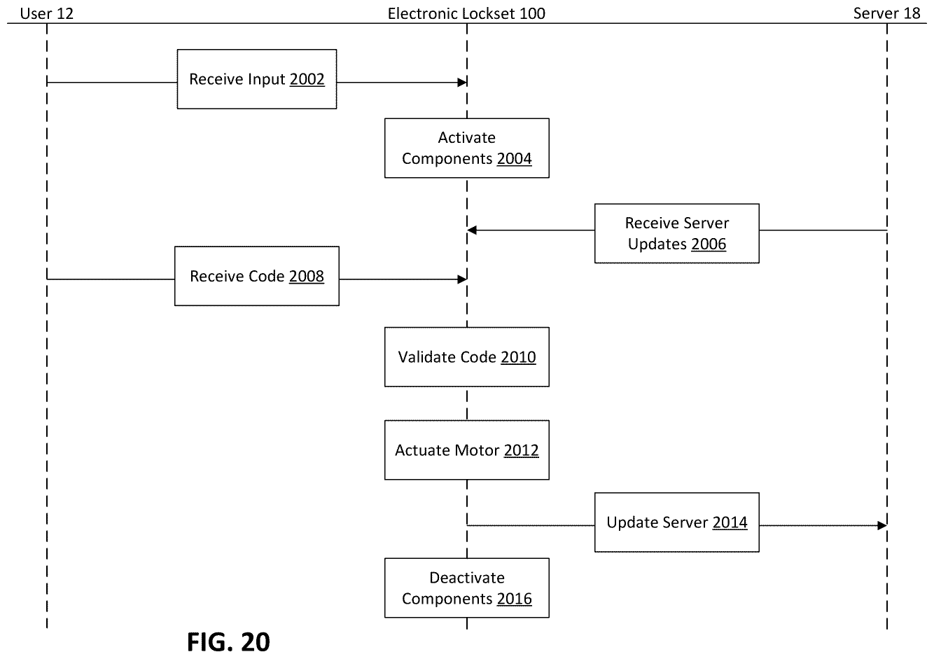

FIG. 20 is a schematic diagram of aspects of the present disclosure. The example of FIG. 20 includes the user 12, the electronic lock 100, and the server 18. In the example of FIG. 20, the electronic lock 100 may include and combine operations described above in connection with the FIGS. 10-19. Although described as being performed by the electronic lock 100, operations illustrated in the example of FIG. 20 may, in some embodiments, be performed by other systems.

In the example shown, the electronic lock 100 may receive an input from the user 12 (operation 2002). In some embodiments, the electronic lock 100 may receive a physical input from the user (e.g., as described above in connection with the FIGS. 10-12). In some embodiments, the input may be from a mobile device associated with the user, such as a mobile device connecting to, sending a communication to, or disconnecting from the electronic lock 100 over a network.

In the example shown, the electronic lock 100 may activate components (step 2004). For example, circuitry of the electronic lock 100 may be connected or activated in response to the user input. As a result, one or more components of the electronic lock 100 may receive power, such as a keypad, motor, memory, one or more network interfaces, or another component. Additionally, in some embodiments, the electronic lock 100 may activate one or more components irrespective of whether a circuit is physically closed by the user input. For example, in response to the user input, the electronic lock 100 may activate one or more network interfaces or other components using software or a combination of software and hardware.

In the example shown, the electronic lock 100 may receive updates from the server 18 (step 2006). For example, upon activating the components, the electronic lock 100 may, in some instances, become communicatively coupled with the server 18. The server 18 may then send updates to the electronic lock, as described, for example, in connection with the step 1108 of FIG. 11.

In the example shown, the electronic lock 100 may receive a code form the user 12 (step 2008). In some embodiments, the code may be input via a keypad or other input device of the electronic lock 100. In some embodiments, the code may be sent by the mobile device 200 to the electronic lock 100. In some embodiments, the electronic lock 100 may receive the code along with the initial user input. An example of receiving a code is described above in connection with the step 1006 of FIG. 10.

In the example shown, the electronic lock 100 may determine whether the code received by the user is valid (step 2010). An example of determining whether a code is valid is described above in connection with the step 1008 of FIG. 10. In response to determining that the code is valid, the electronic lock 100 may actuate the motor (step 2012), an example of which is described above in connection with the step 1010 of FIG. 10. In some embodiments, the electronic lock 100 may then update the server (step 2014), an example of which is described above in connection with the step 1116 of FIG. 11.

In the example shown, the electronic lock 100 may deactivate components (step 2016). In some embodiments, a circuit of the electronic lock 100 may be opened, thereby causing one or more components, such as a motor, keypad, network interface, or other component to lose power and deactivate. In some embodiments, the electronic lock 100 may power down one or more components, or a functionality of one or more components, irrespective of whether a circuitry is physically opened. In some embodiments, the electronic lock 100 may deactivate one or more components that were activated at the step 2004.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

1. An electronic lock comprising:
a switch;
a physically manipulatable component coupled to the switch; and
an electrical circuit including a battery, a processor, and a keypad;
wherein a movement of the physically manipulatable component by a user causes the switch to move from an open position to a closed position or from the closed position to the open position;
wherein the switch, when in a closed position, activates the processor and the keypad by coupling the battery to the processor and the keypad;
wherein the switch, when in an open position, deactivates the processor and the keypad by opening the electrical circuit and electrically disconnecting the battery from the processor and the keypad; and
wherein the processor, when activated, is configured to actuate a bolt when a user is authenticated to gain entry.

2. The electronic lock of claim 1, wherein the physically manipulatable component is one or more of a slidable cover or a button.

3. The electronic lock of claim 1,
further comprising a battery charging system electrically coupled to the battery;
wherein the battery charging system includes one or more of a solar panel or a signal harvesting device.

4. The electronic lock of claim 1, wherein the movement of the physically manipulatable component is caused by the user applying a force to the physically manipulatable component or by the user releasing the physically manipulatable component.

5. The electronic lock of claim 1,
wherein the electronic lock does not include wireless communication capabilities; and
wherein the processor, when activated is further configured to:
receive a code via the keypad;
validate the code; and
in response to validating the code, actuate the bolt.

6. The electronic lock of claim 1,
further comprising a network interface configured to communicate with a remote server;
wherein the electrical circuit further includes the network interface;
wherein the switch, when in the closed position, activates the network interface;
wherein the switch, when in the open position, deactivates the network interface; and
wherein the processor, when activated, is further configured to perform one or more of:
provide updates to the remote server via the network interface; or
receive updates from the remote server via the network interface.

7. The electronic lock of claim 1, wherein coupling the battery to the processor and the keypad comprises closing the electrical circuit and electrically coupling the battery to the processor and the keypad.

8. The electronic lock of claim 1,
wherein a default position of the switch is the open position; and
wherein the physically manipulatable component is configured, absent an external force, to move the switch to the open position.

9. The electronic lock of claim 1, wherein the movement of the physically manipulatable component exposes the keypad on a front surface of the electronic lock.

10. The electronic lock of claim 1,
wherein validating the code is performed by comparing the code to a preprogrammed code stored in a memory of the electronic lock; and
wherein actuating the bolt comprises using an electrical motor to move the bolt from a locked position to an unlocked position or from the unlocked position to the locked position.

11. A power-saving electronic lock comprising:
a processor; and
a memory storing instructions that, when executed by the processor, cause the power-saving electronic lock to:
detect a first input;
based on the detection of the first input, activate an electrical component of the electronic lock;
receive a code;
validate the code;
in response to validating the code, actuate a bolt to move the electronic lock from a locked state to an unlocked state or from the unlocked state to the locked state;
detect a second input; and
based on the detection of the detection of the second input, deactivate the electrical component of the electronic lock.

12. The power-saving electronic lock of claim 11,
wherein the first input is a movement of a physically manipulatable component coupled to a switch; and
wherein the first input causes the switch to close an electrical circuit that couples a power source with the electrical component.

13. The power-saving electronic lock of claim 11,
wherein the power-saving electronic lock is in a low-power standby mode prior to activating the electrical component of the electronic lock; and
wherein the electrical component is a network interface.

14. The power-saving electronic lock of claim 11, wherein detecting the first input comprises receiving an initial communication via a network interface from a mobile device.

15. The power-saving electronic lock of claim 11,
wherein detecting the first input comprises detecting that a user left a location premises at which the electronic lock is located;
wherein the electrical component is a network interface for remotely communicating with a mobile device of the user; and
wherein detecting the second input comprises detecting that the user entered the premises.

16. The power-saving electronic lock of claim 15, wherein detecting that the user left the location or premises at which the electronic lock is located is performed by one or more of determining a location of the mobile device, determining a connection status of the mobile device with the electronic lock, using a geofence to determine that the user left the premises, using a sensor to determine that the user left the premises, or using a video camera.

17. The power-saving electronic lock of claim 11,
wherein the second input is an indication that a battery life has fallen below a threshold value; and
wherein deactivating the electrical component of the electronic lock comprises putting the electronic component into a low-power mode.

18. The power-saving electronic lock of claim 11,
wherein the instructions, when activated, further cause the power-saving electronic lock to receive a communication from one or more of a mobile device or a remote server using the electrical component;
wherein receiving the communication from one or more of the mobile device or the remote server using the electrical component comprises receiving the code via a keypad or receiving an update from the remote server, the update related to an update to software of the electronic lock or an update to a programmable code; and
wherein the instructions, when executed by the processor, further cause the power-saving lock to provide a status to the remote server, the status including one or more of a lock position, a lock actuation event, a date, a time, or a battery life.

19. The power-saving electronic lock of claim 11,
wherein detecting the first input comprises detecting, based on an activation schedule, that the electrical component is scheduled to be active; and
wherein detecting the second input comprises detecting, based on the activation schedule, that the electrical component is schedule to be deactivated.

20. An electronic lock with battery use mitigation, the electronic lock comprising:
a processor; and
a memory storing instructions that, when executed by the processor, cause the electronic lock to:
detect a first input, the first input being one or more of a physical manipulation of a component of the electronic lock, a communication received via a low-power network interface, a communication received via a high-power network interface, a detected location of a mobile device, a detection that the mobile device exited a geofence, a connection status of the mobile device, a determination that an electrical component is scheduled to be active, a determination that a battery life is above a threshold, detected locations of a plurality of registered users or paired users, connection statuses of the plurality of registered users or paired users, an actuation of the electronic lock using a physical key, or data from a video camera or a sensor;
based on the detection of the first input, activate an electrical component of the electronic lock, the electrical component being one or more of a processor, a memory, a keypad, a motor, the low-power network interface, the high-power network interface, the sensor, or the video camera;
receive a code, the code being received via a keypad or via a wireless connection with the mobile device;
validate the code;
in response to validating the code, actuate a bolt to move the electronic lock from a locked state to an unlocked state or from the unlocked state to the locked state;
detect a second input, the second input being one or more of a movement of the component of the electronic lock, a second communication received via the low-power network interface, a second communication received via the high-power network interface, a second detected location of the mobile device, a detection that the mobile device entered the geofence, a second connection status of the mobile device, a determination that the electrical component is scheduled to be deactivated, a determination that the battery life is below the threshold, second detected locations of the plurality of registered users or paired users, second connection statuses of the plurality of registered users or paired users, a second actuation of the electronic lock using the physical key, second data from the video camera or the sensor, or an expiration of a timer or a time delay; and
based on the detection of the second input, deactivate the electrical component of the electronic lock, wherein deactivating the electrical component comprises one or more of disconnecting the electrical component from a power source, powering off the electrical component, or putting the electrical component in a low power mode;
wherein activating the electrical component comprises closing a mechanical switch or an electrical switch to connect the electrical component with a power source.
